(19) United States
(12) Patent Application Publication
(10) Pub. No.: US 2016/0264065 A1
(43) Pub. Date: Sep. 15, 2016

(54) VEHICLE-MOUNTED CAMERA, METHOD OF MANUFACTURING VEHICLE-MOUNTED CAMERA, AND METHOD OF MANUFACTURING VEHICLE BODY

(71) Applicant: NIDEC ELESYS CORPORATION, Kawasaki-shi (JP)

(72) Inventor: Naoya TAKEDA, Kawasaki-shi (JP)

(21) Appl. No.: 15/067,503

(22) Filed: Mar. 11, 2016

(30) Foreign Application Priority Data
Mar. 12, 2015 (JP) 2015-049503
Nov. 25, 2015 (JP) 2015-229891
Mar. 7, 2016 (JP) 2016-043680

(51) Int. Cl. B60R 11/04

(52) U.S. Cl. CPC B60R 11/04

(57) ABSTRACT

A method of manufacturing a vehicle-mounted camera includes previously assuming a plurality of inclination angles as the inclination angles of the glass surface; previously assuming a plurality of positioning angles less than the number of the plurality of inclination angles; determining an inclination angle of the glass surface of the vehicle body on which the vehicle-mounted camera is to be mounted; selecting at least one positioning angle from the assumed plurality of positioning angles; preparing a positioner having the selected positioning angle; and fixing the camera main structure assembly and the selected positioner to the cover enclosure.

### BACKGROUND OF THE INVENTION

1. Field of the Invention

The present invention relates to a vehicle-mounted camera, a method of manufacturing the vehicle-mounted camera, and a method of manufacturing a vehicle body including the vehicle-mounted camera.

2. Description of the Related Art

Conventionally, a vehicle-mounted camera that picks out traffic lanes on a road surface, preceding vehicles, oncoming vehicles, passersby, or road signs by processing images captured by the camera mounted on a vehicle has been used. The vehicle-mounted camera is applied to a vehicle-mounted system that supports the driving safety of the vehicle.

In recent years, a variety of sensors, such as a rain sensor, an illuminance sensor, and a millimeter-wave or laser radar sensor have been mounted on vehicles. Therefore, an attachment space for a vehicle-mounted camera is required to be small. Further, the vehicle-mounted camera needs to be prevented from hindering driving of a driver by, for example, blocking a driver's view or giving a feeling of oppression to the driver. The vehicle-mounted camera is thus attached along the front windshield of the vehicle.

When the vehicle-mounted camera is attached to the vehicle, angle adjustment (e.g., an optical axis adjustment) needs to be performed. Japanese Patent Laid-Open No. 2010-89745 describes an optical-axis adjustment system including driving means for driving the position of a vehicle-mounted camera through operation from the outside, and retaining means for retaining this driving means in a predetermined position.

However, since the vehicle-mounted camera described in Japanese Patent Laid-Open No. 2010-89745 is provided with an angle adjustment mechanism, such as the driving means and the retaining means, the number of components increases and the structure of the camera becomes complex. As a result, the disclosure in Japanese Patent Laid-Open No. 2010-89745 leads to an increase in cost and size of the camera.

### SUMMARY OF THE INVENTION

Preferred embodiments of the present invention have been conceived of and developed in view of the problems of the prior art, and provide a vehicle-mounted camera that allows for easy adjustment of the optical axis angle and reduction in cost and size, a method of manufacturing the vehicle-mounted camera, and a method of manufacturing a vehicle body including the vehicle-mounted camera.

A preferred embodiment of the present application provides a method of manufacturing a vehicle-mounted camera including a cover enclosure including a top plate and a camera main structure assembly fixed to the cover enclosure via a positioner, the vehicle-mounted camera being attached to a glass surface of a windshield inside a vehicle at the top plate and facing forward or rearward of a vehicle body in a position in which the vehicle-mounted camera extends along the window glass, and the vehicle-mounted camera being able to capture an image of a scene on a front or back side of the vehicle body, the method including previously assuming a plurality of inclination angles as the inclination angles of the glass surface; previously assuming a plurality of positioning angles less than the number of the plurality of inclination angles; determining an inclination angle of the glass surface of the vehicle body on which the vehicle-mounted camera is to be mounted; selecting at least one positioning angle from the assumed plurality of positioning angles to prepare a positioner having the selected positioning angle; and fixing the camera main structure assembly and the selected positioner to the cover enclosure, wherein the camera main structure assembly includes a lens and an image sensor, the top plate of the cover enclosure includes an enclosure-side seat, the camera main structure assembly includes a camera-side seat on a surface of the camera main structure assembly, a surface of the positioner includes an enclosure-side locator that makes contact with the enclosure-side seat at at least three enclosure-side contact points, and a camera-side locator that makes contact with the camera-side seat at at least three camera-side contact points, one of the at least three enclosure-side contact points is located in a position deviated from a straight line passing through the other two points, one of the at least three camera-side contact points is located in a position deviated from a straight line passing through the other two points, the positioning angle is a difference between a direction determined by the at least three enclosure-side contact points and a direction determined by the at least three camera-side contact points, and the positioning angle is selected by a predetermined method of referring to the determined inclination angle of the glass surface, a difference between the direction determined by the at least three enclosure-side contact points and a direction of the glass surface, and a difference between the direction determined by the at least three camera-side contact points and a direction of an optical axis of the camera main structure assembly.

According to one preferred embodiment of the present invention, there is provided a vehicle-mounted camera capable of being easily adjusted in optical axis angle and reduced in cost and size.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic cross-sectional view of a vehicle body according to a preferred embodiment of the present invention.

FIG. 2 is an exploded perspective view of a vehicle-mounted camera according to a preferred embodiment of the present invention.

FIG. 3 is an exploded side view of a vehicle-mounted camera according to a preferred embodiment of the present invention.

FIG. 4 is an exploded perspective view of the vehicle-mounted camera according to a preferred embodiment of the present invention.

FIG. 5 is an enlarged view of fixed portions between a positioner according to a preferred embodiment of the present invention and a camera main structure assembly and between the positioner and a cover enclosure.

FIG. 6 is a perspective view of the vehicle-mounted camera according to a preferred embodiment of the present invention and a mounting member.

FIG. 7 is a side view of the vehicle-mounted camera according to a preferred embodiment of the present invention, illustrating a state of the camera being attached to a front windshield.

FIG. 8 is a cross-sectional view of a vehicle-mounted camera according to a preferred embodiment of the present invention, illustrating a state of the camera being attached to the front windshield.

FIG. 9 is a cross-sectional view of a vehicle-mounted camera according to a preferred embodiment of the present invention, illustrating a state of the camera being attached to the front windshield.

FIG. 10 is an exploded perspective view of a vehicle-mounted camera of Variation 1 of a preferred embodiment of the present invention.

FIG. 11 is a cross-sectional view of the vehicle-mounted camera of Variation 1 of a preferred embodiment of the present invention, illustrating a state of the camera being attached to a front windshield.

FIG. 12 is an exploded perspective view of a vehicle-mounted camera of Variation 2 of a preferred embodiment of the present invention.

FIG. 13 is a cross-sectional view of the vehicle-mounted camera of Variation 2 of a preferred embodiment of the present invention, illustrating a state of the camera being attached to a front windshield.

FIG. 14 is a partial schematic view of a vehicle-mounted camera of Variation 3 of a preferred embodiment of the present invention.

FIG. 15 is a perspective view taken by enlarging a fixed portion between a positioner and a cover enclosure in the vehicle-mounted camera of Variation 3 of a preferred embodiment of the present invention.

FIG. 16 is a partial schematic view of a vehicle-mounted camera of Variation 4 of a preferred embodiment of the present invention.

FIG. 17 is a perspective view taken by enlarging a fixed portion between a positioner and a cover enclosure in the vehicle-mounted camera of Variation 4 of a preferred embodiment of the present invention.

FIG. 18 is a partial schematic view of a vehicle-mounted camera of Variation 5 of a preferred embodiment of the present invention.

FIG. 19 is a perspective view taken by enlarging a fixed portion between a positioner and a cover enclosure in the vehicle-mounted camera of Variation 5 of a preferred embodiment of the present invention.

FIG. 20 is a perspective view of a camera main structure assembly and a positioner mounted on a vehicle-mounted camera of Variation 6 of a preferred embodiment of the present invention.

FIG. 21 is a partial schematic view of the vehicle-mounted camera of Variation 6 of a preferred embodiment of the present invention.

### DETAILED DESCRIPTION OF THE PREFERRED EMBODIMENTS

Hereinafter, vehicle-mounted cameras according to preferred embodiments of the present invention will be described with reference to the accompanying drawings.

It should be noted that drawings to be referred to in the following description may show characterizing portions in enlarged view, as a matter of convenience, for the purpose of emphasizing the portions. Accordingly, the dimensional ratio and the like of each constituent element are not necessarily the same as the actual dimensional ratio and the like thereof. In addition, for the same purpose, non-characterizing portions may be excluded from the included illustrations.

In addition, in the following description of the vehicle-mounted camera 100, the vehicle width direction of a vehicle body 1 when the vehicle-mounted camera 100 is mounted on the vehicle body 1 is defined as the width direction or left-right direction of the vehicle-mounted camera 100, the front-back direction of the vehicle body 1 is defined as the front-back direction of the vehicle-mounted camera 100, and the vertical direction of the vehicle body 1 is defined as the vertical direction of the vehicle-mounted camera 100. Note that the positions and the layout of respective members of the vehicle-mounted camera 100 are for illustrative purposes only and may be modified without departing from the spirit of the present invention.

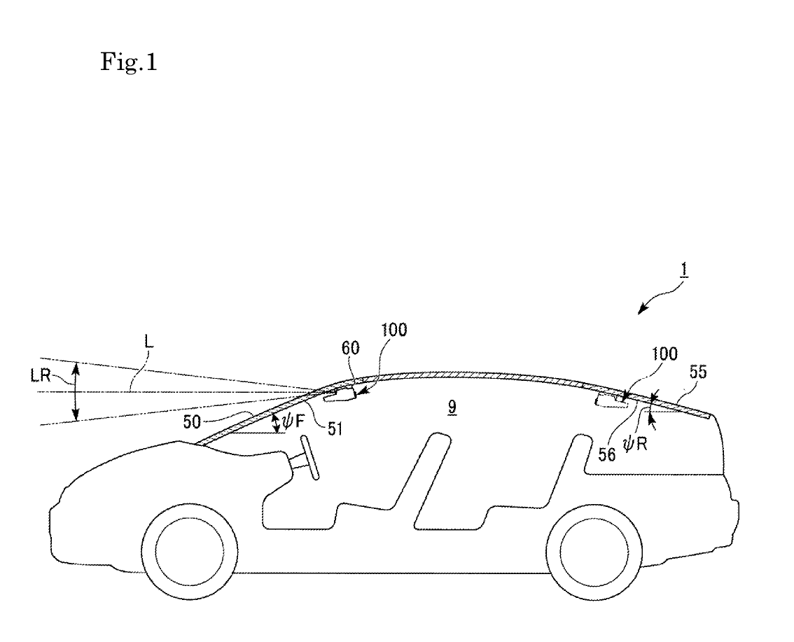

FIG. 1 is a schematic cross-sectional view of the vehicle body 1 on which the vehicle-mounted camera 100 is mounted. The vehicle body 1 includes a windshield 50 facing forward (hereinafter referred to as the front windshield), and a windshield 55 facing rearward (hereinafter referred to as the rear windshield). The vehicle-mounted camera 100 is preferably attached to a glass surface 51 of the front windshield 50 on the vehicle interior 9 side thereof and used to capture an image of a scene on the front side of the vehicle body 1.

Note that as shown by double-dashed lines in FIG. 1, the vehicle-mounted camera 100 may be attached to a glass surface 56 of the rear windshield 55 on the vehicle interior 9 side thereof. When the vehicle-mounted camera 100 is attached to the rear windshield 55, the vehicle-mounted camera 100 is used to capture an image of a scene on the back side of the vehicle body 1.

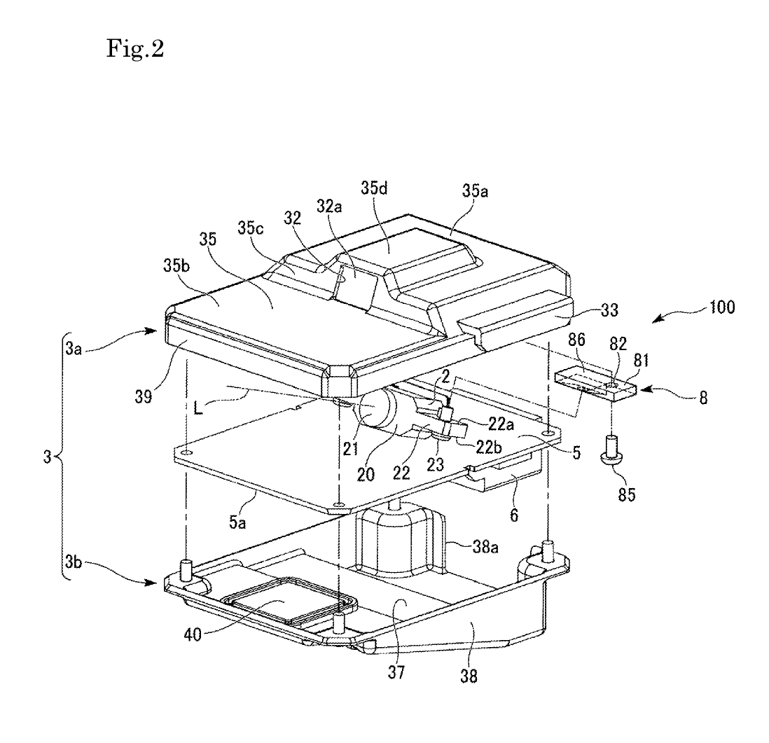

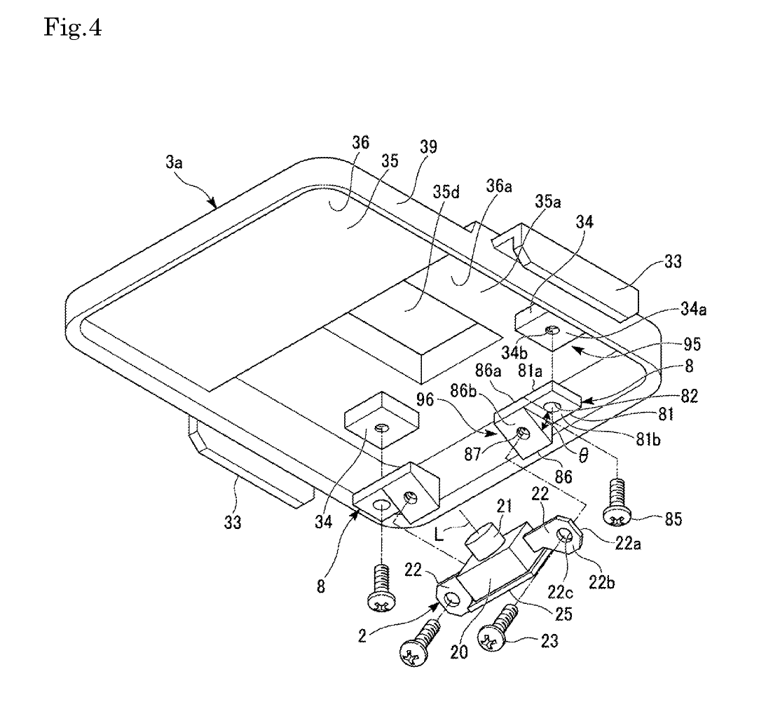

FIGS. 2 to 4 are exploded views of the vehicle-mounted camera 100. Note that in FIG. 4, a processor board 5 and a base enclosure 3b are excluded from the illustration.

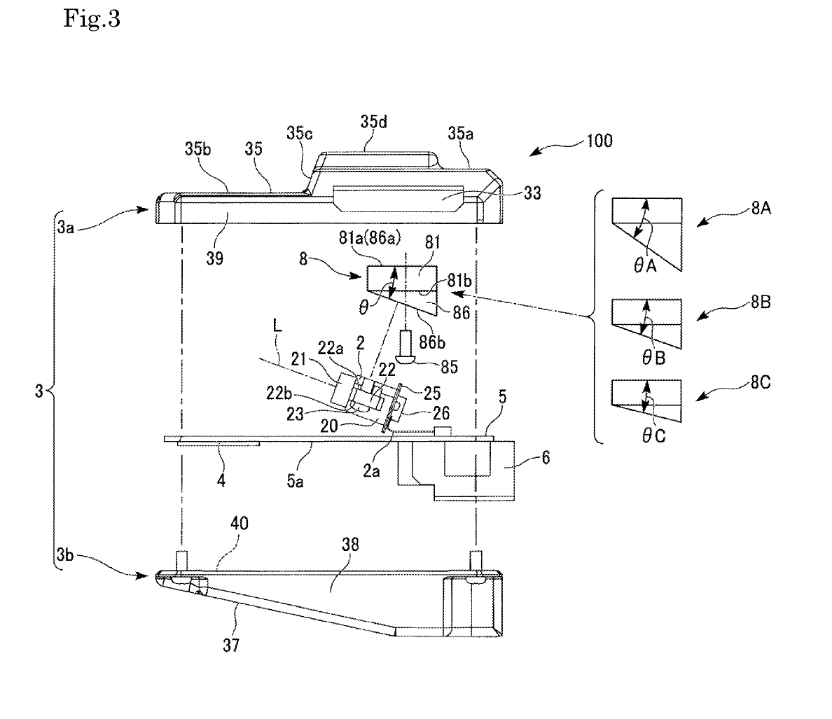

As illustrated in FIGS. 2 and 3, the vehicle-mounted camera 100 includes an enclosure 3; a camera main structure assembly 2; a positioner 8; and a processor board 5. The enclosure 3 includes a cover enclosure 3a and a base enclosure 3b.

The processor board 5 controls the camera main structure assembly 2 to capture a stream of images and stores the captured images or transfers the captured images to another device. As illustrated in FIG. 3, circuitry including: a processor circuit 4, a connector 6, a power circuit, a capacitor, a microcomputer, an IC, and the like, some of which are not illustrated in the drawings, are preferably mounted on the processor board 5. In addition, the processor board 5 is connected to the camera main structure assembly 2 via a wire 2a.

The processor circuit 4 electronically processes images captured by an image sensor 26 of the camera main structure assembly 2. The processor circuit 4 is disposed on the front portion of a lower surface 5a of the processor board 5. The processor circuit 4 performs a process of extracting various characteristic objects, including vehicles, pedestrians and traffic lanes, with regard to visual information on images captured by the image sensor. The processor circuit 4 makes contact with the base enclosure 3b via a heat radiation member 40. Examples of the heat radiation member 40 include a heat radiation plate (sheet) and a heat radiation gel. A silicon-based material or the like is used as the material of a heat radiation plate (sheet) and a heat radiation gel. The processor circuit 4 generates heat when the vehicle-mounted camera 100 is driven. The heat radiation performance of the vehicle-mounted camera 100 is improved by bringing the processor circuit 4 into contact with the base enclosure 3b via the heat radiation member 40.

A wire extending to external equipment (not shown) is connected to the connector 6 (power supply connector). The connector 6 is preferably disposed on the rear portion of a lower surface 5a of the processor board 5. The connector 6 is used to supply electric power and communication to the vehicle-mounted camera 100.

The enclosure 3 houses the processor board 5 and the components on the processor board 5, the camera main structure assembly 2, and the positioners 8.

The enclosure 3 preferably includes a cover enclosure 3a that supports the camera main structure assembly 2, and a base enclosure 3b attached to the lower side of the cover enclosure 3a to support the processor board 5. Note that the enclosure 3 may not include the base enclosure 3b. If the enclosure 3 does not include the base enclosure 3b, the processor board 5 is fixed to the lower surface of the cover enclosure 3a.

As illustrated in FIG. 2, the cover enclosure 3a includes a top plate 35, and a peripheral edge portion 39 extending downward from a peripheral edge of the top plate 35. The peripheral edge portion 39 of the cover enclosure 3a is screw-fixed to the base enclosure 3b. Note that the cover enclosure 3a may not include the peripheral edge portion 39 as long as the enclosure includes the top plate 35.

The top plate 35 includes a front portion 35b, a rear portion 35a, and a riser 35c. The front portion 35b is located in a front region of the top plate 35. The rear portion 35a is located posterior to the front portion 35b. In addition, the rear portion 35a is located higher than the front portion 35b. The riser 35c is located between the rear portion 35a and the front portion 35b.

A camera housing 35d is preferably provided at the center in the width-direction of the rear portion 35a. The camera housing 35d protrudes upward from the rear portion 35a. The camera main structure assembly 2 is housed in a space under the camera housing 35d.

A viewing window 32 is provided in a portion of the riser 35c located on the front side of the camera housing 35d. The viewing window 32 is an opening through which an optical axis L of the camera main structure assembly 2 passes. The camera main structure assembly 2 captures images outside the vehicle through the viewing window 32. The viewing window 32 is closed with a transparent plate 32a that prevents the ingress of dust into the inner side of the enclosure 3.

As illustrated in FIG. 4, a pair of enclosure-side seats 34 protruding downward are disposed in a lower-side rear portion 36a of a lower surface 36 of the top plate 35 located on the lower side of the rear portion 35a. The pair of enclosure-side seats 34 are positioned on the left and right sides of the camera housing 35d, respectively.

In the present preferred embodiment, each enclosure-side seat 34 preferably has a quadrangular prismatic shape. Each enclosure-side seat 34 has a flat enclosure-side seat surface 34a on the lower side thereof. The enclosure-side seat surface 34a is a surface that supports the positioner 8 from above. A screw hole 34b used in screw-fastening the positioner 8 is preferably provided in the enclosure-side seat surface 34a.

As illustrated in FIG. 4, mounting projections 33 are preferably disposed on both sides of the peripheral edge portion in the width-direction of the cover enclosure 3a. The mounting projections 33 are used in mounting the vehicle-mounted camera 100 on the vehicle body 1. The mounting of the vehicle-mounted camera 100 on the vehicle body 1 is described later.

The base enclosure 3b covers the processor board 5 from below. The height of the base enclosure 3b preferably gradually decreases from the rear side toward the front side of the enclosure. The base enclosure 3b preferably includes a sidewall portion 38 and a bottom portion 37. A heat radiation member 40 is provided in a position where a front portion of the bottom portion 37 makes contact with the processor circuit 4. The sidewall portion 38 extends upward from a peripheral edge of the bottom portion 37. An opening 38a is provided in the rear portion of the sidewall portion 38. The connector 6 mounted on the processor board 5 is exposed rearward from the opening 38a, thus enabling a wire (not shown) that extends to external equipment to be connected to the connector.

In the present preferred embodiment, the cover enclosure 3a and the base enclosure 3b are preferably made from aluminum or an aluminum alloy and produced by pressing or by a pressure die casting, for example. By making the cover enclosure 3a and the base enclosure 3b from aluminum or an aluminum alloy, it is possible to enhance the thermal capacity of the enclosure as a whole and transfer heat generated from the processor board 5 to effectively cool the processor board 5.

In addition, as illustrated in FIG. 4, each positioner is preferably fixed to the cover enclosure 3a at the enclosure-side seat 34. By making the cover enclosure 3a from aluminum or an aluminum alloy, it is possible to prevent deformation due to external force and ensure the mounting accuracy of the positioner 8.

The camera main structure assembly 2 is a device used to capture an image of a foreground of the vehicle body 1 as visual information.

As illustrated in FIG. 3, the camera main structure assembly 2 has one optical axis L. The camera main structure assembly 2 preferably includes a base 20, a lens 21, an image sensor board 25, and an image sensor 26. The camera main structure assembly 2 is fixed to the cover enclosure 3a via the positioners 8.

The lens 21 preferably includes a plurality of lenses the optical axes of which are aligned, and a cylindrically-shaped tubular portion that holds the lenses. The common optical axis of the plurality of lenses is the optical axis L of the camera main structure assembly 2. The lens 21 is fixed to the base 20 so as to project forward from the base 20. The image sensor 26 is disposed in the rear of the lens 21.

The image sensor board 25 is fixed on the rear surface of the base 20. The image sensor 26 is mounted on the image sensor board 25.

The image sensor 26 captures images of an outside world as visual information. The image sensor 26 captures a subject image formed through the lens 21. A CMOS image sensor, for example, is preferably used as the image sensor 26.

The base 20 penetrates through the lens 21. The base 20 holds the outer periphery of the lens 21.

In addition, as illustrated in FIG. 4, a pair of camera-side seats 22 extending outward are disposed on both sides of the base 20 in the width direction thereof.

Each camera-side seat 22 includes a camera-side seat surface 22a which is a surface parallel or substantially parallel to the optical axis L. Each camera-side seat 22 also includes a lower surface 22b positioned on the opposite side of the camera-side seat surface 22a. A through-hole 22c open in the camera-side seat surface 22a and the lower surface 22b is provided in the camera-side seat 22. A screw 23 used to screw-fasten the camera main structure assembly 2 to the positioner 8 is preferably inserted in the through-hole 22c.

Each camera-side seat 22 is a portion extending in a direction away from the optical axis L of the lens 21. That is, each camera-side seat 22 spreads outward from the inner side of a virtual circle around the optical axis L. Each camera-side seat 22 may not necessarily extend toward a radial direction. Each camera-side seat 22 is preferably located away from the optical axis L. Consequently, it is possible to sufficiently secure an amount of distance between a tool used to fasten the screw 23 and the lens 21, and an amount of distance between the tool and the image sensor 26 in a fixing process of a positioner 8 to the camera-side seat 22. This makes it possible to prevent damage to the lens 21 and the image sensor 26 in an assembly process and make assembly work easy.

As illustrated in FIG. 4, the positioners 8 are preferably provided in a pair for the vehicle-mounted camera 100. The positioners 8 are disposed between the cover enclosure 3a and the camera main structure assembly 2 to define the mounting angle of the camera main structure assembly 2 around an axis line extending in the width direction of the camera main structure assembly 2 with respect to the cover enclosure 3a.

In the present preferred embodiment, the positioners 8 are preferably made from iron or stainless steel. The positioners 8 made from iron or stainless steel have adequate rigidity and are, therefore, less liable to deformation due to external force. Consequently, it is possible to increase the accuracy of the positioning angle of the positioners 8.

Each positioner 8 preferably includes a first block 81 and a second block 86, both having generally block shapes. Each positioner 8 is disposed such that the first block 81 is positioned on an outer side in the width-direction of the vehicle-mounted camera 100 than the second block 86.

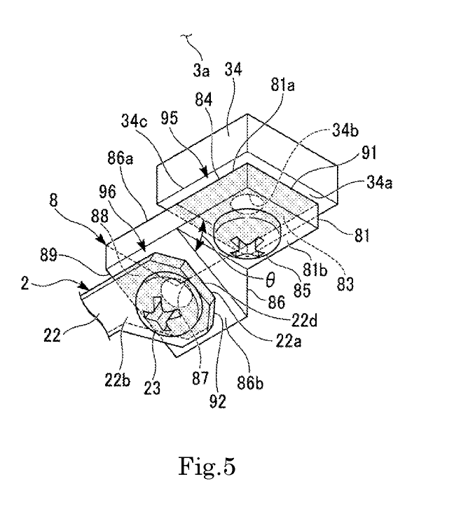

FIG. 5 is an enlarged view of fixed portions between each positioner 8 and the camera main structure assembly 2 and between each positioner 8 and the cover enclosure 3a. As illustrated in FIG. 5, each positioner 8 is fixed together with the cover enclosure 3a at the first block 81 and fixed together with the camera main structure assembly 2 at the second block 86. Here, the fixed portion between the positioner 8 and the cover enclosure 3a is referred to as an enclosure-side fixed portion 95, whereas the fixed portion between the positioner 8 and the camera main structure assembly 2 is referred to as a camera-side fixed portion 96.

Each enclosure-side fixed portion 95 will be described according to FIGS. 4 and 5.

The first block 81 includes an enclosure-side positioner (first block upper surface) 81a positioned on the cover enclosure 3a side (upper side), and a first block lower surface 81b positioned on the opposite side of the first block upper surface 81a. That is, a surface of each positioner 8 preferably includes the enclosure-side positioner 81a. In the present preferred embodiment, the enclosure-side positioner 81a has a flat surface. The enclosure-side positioner (first block upper surface) 81a and the first block lower surface 81b are parallel or substantially parallel to each other.

A through-hole 82 open in the enclosure-side positioner 81a and the first block lower surface 81b is provided in the first block 81. Each positioner 8 is screw-fixed to the enclosure-side seat 34 of the cover enclosure 3a through the through-hole 82 with a screw 85. The enclosure-side positioner 81a makes surface contact with the enclosure-side seat surface 34a of the enclosure-side seat 34.

Contact between the enclosure-side positioner 81a and the enclosure-side seat 34 may not be surface contact. The enclosure-side positioner 81a may make contact with the enclosure-side seat 34 at at least three enclosure-side contact points. In this case, one of the at least three enclosure-side contact points is disposed in a position deviated from a straight line passing through the other two points. By bringing the enclosure-side positioner 81a and the enclosure-side seat 34 into contact with each other at three or more points that do not align on any straight line, the degree of freedom of the enclosure-side positioner 81a with respect to the enclosure-side seat 34 is able to be reduced to zero. Thus, the positioner 8 is stably supported on the enclosure-side seat 34.

Note that since the enclosure-side positioner 81a and the enclosure-side seat 34 are in surface contact with each other in the present preferred embodiment, as illustrated in FIG. 5, enclosure-side contact points exist and define an enclosure-side contact plane 83. Accordingly, the enclosure-side contact plane 83 includes three enclosure-side contact points that do not align on any straight line.

As illustrated in FIG. 5, the enclosure-side seat surface 34a preferably has a rectangular or substantially rectangular shape in which the seat surface is surrounded by a four-side edge portion 34c. Likewise, the enclosure-side positioner 81a preferably has a rectangular or substantially rectangular shape in which the positioner is surrounded by a four-side edge portion 84. The enclosure-side contact plane 83 which is a contact plane between the enclosure-side seat 34 and the enclosure-side positioner 81a defines a rectangular or substantially rectangular external shape in which the contact plane 83 is surrounded by a first edge 91 including three sides originating from the edge portion 84 and one side originating from the edge portion 34c.

At least one (both, in the present preferred embodiment) of the enclosure-side seat 34 and the enclosure-side positioner 81a includes the first edge 91 that makes contact with the other one, and at least one of enclosure-side contact points is positioned on the first edge 91.

In the present preferred embodiment, the positioner 8 and the enclosure-side seat 34 preferably make surface contact with each other. Even if contact between the positioner 8 and the enclosure-side seat 34 is not surface contact, the enclosure-side seat 34 is able to stably support the positioner 8 as the result of the positioner 8 and the enclosure-side seat 34 making contact with each other at the first edge 91.

Next, the camera-side fixed portion 96 will be described according to FIGS. 4 and 5.

The second block 86 includes a second block upper surface 86a positioned on the cover enclosure 3a side, and a camera-side positioner (second block lower surface) 86b positioned on the opposite side of the second block upper surface 86a. That is, a surface of the positioner 8 includes the camera-side positioner 86b. In the present preferred embodiment, the camera-side positioner 86b preferably has a flat surface.

The second block upper surface 86a is continuous with the enclosure-side positioner (first block upper surface) 81a. The camera-side positioner (second block lower surface) 86b inclines toward an upward direction at an positioning angle θ, with respect to other surfaces (the second block upper surface 86a, the first block lower surface 81b and the enclosure-side positioner (first block upper surface) 81a) of the positioner 8, as the positioner 86b extends forward.

A screw hole 87 is preferably provided in the camera-side positioner 86b. The camera-side seat 22 of the camera main structure assembly 2 is screw-fastened to the screw hole 87 with a screw 23. Consequently, the camera main structure assembly 2 is fixed to the positioner 8. The camera-side positioner 86b makes surface contact with the camera-side seat surface 22a of the camera-side seat 22.

As in the case of the enclosure-side fixed portion 95, contact between the camera-side positioner 86b and the camera-side seat 22 may not be surface contact. The camera-side positioner 86b may make contact with the camera-side seat 22 at at least three camera-side contact points. In this case, one of the at least three camera-side contact points is disposed in a position deviated from a straight line passing through the other two points. Consequently, the degree of freedom of the camera-side seat 22 with respect to the camera-side positioner 86b is able to be reduced to zero, as in the case of the enclosure-side fixed portion 95. Thus, the positioner 8 stably supports the camera main structure assembly 2.

The camera-side positioner 86b and the camera-side seat 22 make surface contact with each other in the present preferred embodiment, as in the case of the enclosure-side fixed portion 95. A plurality of camera-side contact points therefore are provided and define a camera-side contact plane 88 (see FIG. 5). Accordingly, the camera-side contact plane 88 preferably includes three camera-side contact points that do not align on any straight line.

As illustrated in FIG. 5, the external shape of the camera-side contact plane 88 is surrounded by a second edge 92 originating from a part of the edge portion 22d of the camera-side seat surface 22a and part of the edge portion 89 of the camera-side positioner 86b.

As in the case of the enclosure-side fixed portion 95, at least one (two, in the present preferred embodiment, for example) of the camera-side seat 22 and the camera-side positioner 86b includes the second edge 92 configured to make contact with the other one, and at least one of camera-side contact points is positioned on the second edge 92. As the result of applying such a configuration as described above, the positioner 8 and the camera-side seat 22 make contact with each other at the second edge 92 even if contact between the positioner 8 and the camera-side seat 22 is not surface contact, and the positioner 8 is able to stably support the camera main structure assembly 2.

In each positioner 8, the enclosure-side positioner 81a which is the upper surface of the first block 81 is preferably a cut surface formed by cutting off a portion of a surface of the positioner. Likewise, in each positioner 8, the camera-side positioner 86b which is the lower surface of the second block 86 is preferably a cut surface formed by cutting off a portion of a surface of the positioner.

Since each cut surface has a high-degree flatness, the mounting accuracy of an object of contact is increased when the object is brought into surface contact with the cut surface. By providing the enclosure-side positioner 81a and the camera-side positioner 86b as cut surfaces, it is possible to increase the positional accuracy of the optical axis L of the camera main structure assembly 2 with respect to the cover enclosure 3a. Note that both of the enclosure-side positioner 81a and the camera-side positioner 86b are most preferably formed as cut surfaces. However, a certain degree of effectiveness is able to be obtained by forming either one of the positioners as a cut surface. If the surface of one of the enclosure-side positioner 81a and the camera-side positioner 86b is formed as a cut surface, the other surface is preferably used as a reference plane at the time of cutting work. Consequently, it is possible to increase the relative positional accuracy of the enclosure-side positioner 81a and the camera-side positioner 86b and thus increase the accuracy of the positioning angle θ.

In addition, not only the positioners 8 but also the enclosure-side seat surface 34a of the cover enclosure 3a making surface contact with the enclosure-side positioner 81a and the camera-side seat surface 22a of the camera main structure assembly 2 making surface contact with the camera-side positioner 86b are more preferably formed as cut surfaces. Consequently, it is possible to make an angle adjustment to the optical axis L with a higher degree of accuracy.

A description will be provided of the mounting of the vehicle-mounted camera 100 on the vehicle body 1.

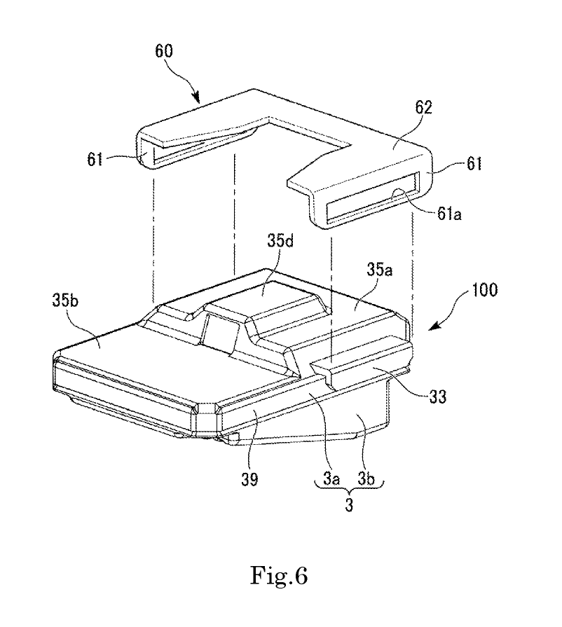

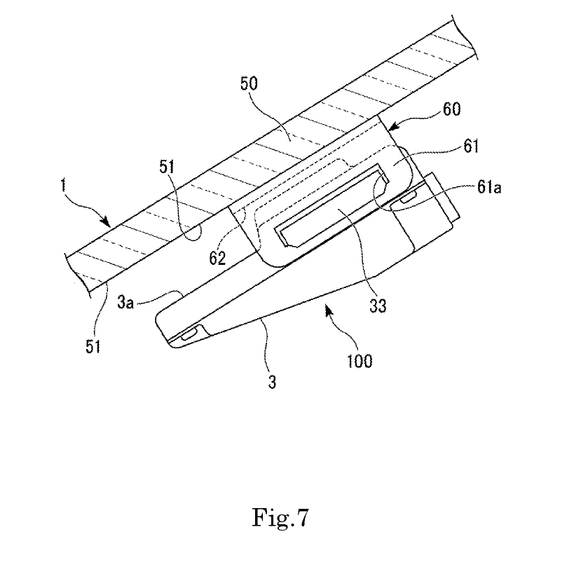

FIG. 6 is a perspective view of the vehicle-mounted camera 100 and a mounting member 60 used to mount the vehicle-mounted camera 100 on the vehicle body 1. FIG. 7 is a side view illustrating a state of the vehicle-mounted camera 100 being mounted on the vehicle body 1.

As illustrated in FIG. 6, the mounting member 60 preferably includes a flat plate-shaped glass surface fixing portion 62, and a pair of support portions 61 extending downward from both width-direction ends of the glass surface fixing portion 62.

The glass surface fixing portion 62 of the mounting member 60 covers the rear portion 35a of the top plate 35 of the cover enclosure 3a, except the camera housing 35d. As illustrated in FIG. 7, the mounting member 60 is fixed to the glass surface 51 of the front windshield 50 on the upper surface of the glass surface fixing portion 62. The glass surface fixing portion 62 and the glass surface 51 are fixed to each other with, for example, a double-sided adhesive tape or an adhesive agent. The mounting member 60 is fixed to a predetermined location of the front windshield 50, for example, a location of the glass surface 51 near a rearview mirror.

A mounting opening 61a is provided in each support portion 61 of the mounting member 60. A mounting projection 33 of the cover enclosure 3a is fitted into the mounting opening 61a. Consequently, the mounting member 60 supports the vehicle-mounted camera 100, while maintaining a relative positional relationship with the vehicle body 1. As the result of the vehicle-mounted camera 100 being attached to the mounting member 60 fixed on the glass surface 51, the top plate 35 of the cover enclosure 3a is positioned along the front windshield 50 of the vehicle body 1. Since the vehicle-mounted camera 100 is attached to the glass surface 51 so as to be located along the glass surface 51, the vehicle-mounted camera 100 does not block the forward vision of the driver.

As illustrated in FIG. 1, the glass surface 51 of the front windshield 50 of the vehicle body 1 is inclined at an inclination angle ΨF. This inclination angle ΨF varies depending on the type of vehicle body 1. Hereinafter, a description will be provided of a method of manufacturing the vehicle-mounted camera 100 that can be mounted on the vehicle body 1 having various inclination angles ΨF, with the optical axis L of the camera main structure assembly 2 set at a preferred angle.

Note that when the vehicle-mounted camera 100 is attached to the glass surface 56 of the rear windshield 55, the optical axis L of the camera main structure assembly 2 is set at a preferred angle with respect to the inclination angle ΨR of the glass surface 56 different for each type of vehicle in the same way as will be described hereinafter.

In general, the front windshield 50 is preferably curved from the center toward the width direction thereof. In the present preferred embodiment, the vehicle-mounted camera 100 is assumed to be attached to the center in the width direction of the front windshield 50, and therefore, the curvature of the front windshield 50 is ignored. Note that if the vehicle-mounted camera 100 is attached to the front windshield 50 in a position displaced to one side in the width direction of the front windshield 50, the optical axis L inclines toward the left-right direction of the front windshield 50. In this case, any inclination toward the left-right direction is able to be corrected by image processing in the processor circuit 4.

As illustrated in FIG. 1, the vehicle-mounted camera 100 is mounted on the vehicle body 1, so that the optical axis L falls within the tolerable direction range LR having a predetermined angular width. If the optical axis L falls outside the tolerable direction range LR, the vehicle-mounted camera 100 fails to secure a sufficient field of view of the camera main structure assembly 2, and therefore the vehicle-mounted camera 100 cannot obtain a sufficient amount of information necessary for vehicle body control from captured images. The tolerable direction range LR is previously set on the basis of the horizontal direction of the front windshield 50.

Unless otherwise specified in the following description, a horizontal direction included in the tolerable direction range LR is selected as the direction of the optical axis L.

First, the assumption of the positioning angle θ of the vehicle-mounted camera 100 in a design phase will be described according to FIGS. 1 and 3.

In a design phase, various types of vehicle bodies 1 are previously assumed as mounting objects on which the vehicle-mounted camera 100 is to be mounted. Also in a design phase, a plurality of inclination angles ΨF are previously assumed as an inclination angle defined by the glass surface 51 of the front windshield 50 of the vehicle body 1 to which the vehicle-mounted camera 100 is to be attached. The plurality of inclination angles ΨF are, for example, inclination angles ΨF within a predetermined angular range (for example, about 20° to about 50°).

As illustrated in FIG. 3, a plurality of positioning angles θA, θB, θC, . . . , smaller in number than the plurality of inclination angles ΨF, are previously assumed for the vehicle-mounted camera 100 in a design phase. The previously assumed plurality of positioning angles θA, θB, θC, correspond to the inclination angles ΨF within the predetermined angular range and are assumed to vary in increments of, for example, about 3°. Accordingly, the angular range of the inclination angles ΨF of the front windshield 50 from about 20° to about 50° (an approximately 30° span) means that eleven positioning angles are assumed.

The vehicle-mounted camera 100 is manufactured on the basis of the above-described plurality of inclination angles ΨF and plurality of positioning angles θA, θB, θC, previously assumed in a design phase.

Now, a description will be provided of the way the positioning angle θ of the vehicle-mounted camera 100 is selected in an assembly phase.

The inclination angle ΨF defined by the glass surface 51 of the front windshield 50 of the vehicle body 1 to which the vehicle-mounted camera 100 is to be attached is determined at the time of assembling the vehicle-mounted camera 100. The inclination angle ΨF can be determined by actually measuring the inclination angle ΨF of the vehicle body 1 which is an object of mounting. Alternatively, as the inclination angle ΨF, the inclination angle ΨF of a targeted vehicle body 1 may be determined from a database of inclination angles for various types of vehicles.

Next, at least one positioning angle θA is selected from the previously-assumed positioning angles θA, θB, θC, . . . on the basis of the determined inclination angle ΨF of the glass surface 51 of the vehicle body 1.

A preferred method of selecting the positioning angle θ will be described in detail later.

Next, positioners 8A having the selected positioning angle θA are prepared. The positioners 8 having the positioning angle θA may be prepared by manufacturing the positioners 8A or by, for example, purchasing commercially available positioners 8A. In addition, only one type of positioners 8 having the selected positioning angle θA may be prepared or a plurality of positioners 8A, 8B and 8C having respective positioning angles θA, θB and θC may be prepared in advance. In the latter case, positioners 8 to be actually used in mounting are selected at the time of assembly.

There may be a plurality of positioning angles θA selected on the basis of the determined inclination angle ΨF of the glass surface 51 of the vehicle body 1. For example, a plurality of positioning angles θA and θB can be selected for the inclination angle ΨF in some cases. As illustrated in FIG. 1, the direction of the optical axis L of the camera main structure assembly 2 may fall within the tolerable direction range LR. Accordingly, the plurality of positioning angles θA and θB can be selected as long as the optical axis L falls within the tolerable direction range LR. In this case, the plurality of positioning angles θA and θB are selected and positioners 8A and 8B respectively having one of the selected plurality of positioning angles θA and θB can be prepared. Then, positioners 8A (or positioners 8B) of one type are selected from the selected plurality of types of positioners 8A and 8B.

Next, as illustrated in FIGS. 4 and 5, the selected positioners 8(8A) and the camera main structure assembly 2 are fixed to the cover enclosure 3a. For example, the positioners 8(8A), after being fixed to the camera-side seats 22 of the camera main structure assembly 2, may preferably be fixed to the enclosure-side seats 34 of the cover enclosure 3a. Note that the order in which the camera main structure assembly 2 and the positioners 8(8A) are fixed to the cover enclosure 3a is not limited.

The vehicle-mounted camera 100 adapted to various types of vehicles can be manufactured by going through the above-described steps.

Next, a description will be provided of a method of selecting one positioning angle θA or θB from a plurality of positioning angles θA, θB, θC, . . . .

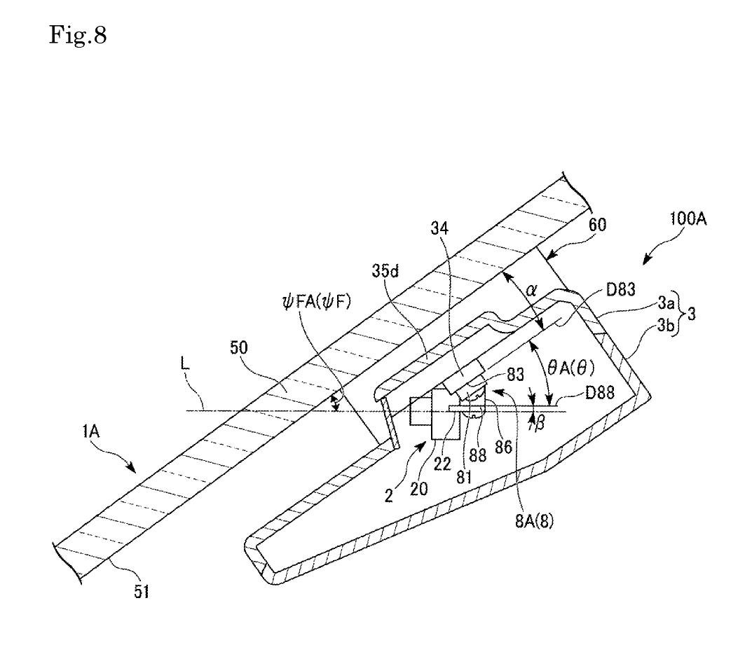

FIG. 8 is a cross-sectional view of a vehicle-mounted camera 100A for which positioners 8A having a positioning angle θA are selected, illustrating a state of the vehicle-mounted camera 100A being mounted on a vehicle body 1A. The front windshield 50 of the vehicle body 1A has an inclination angle ΨFA.

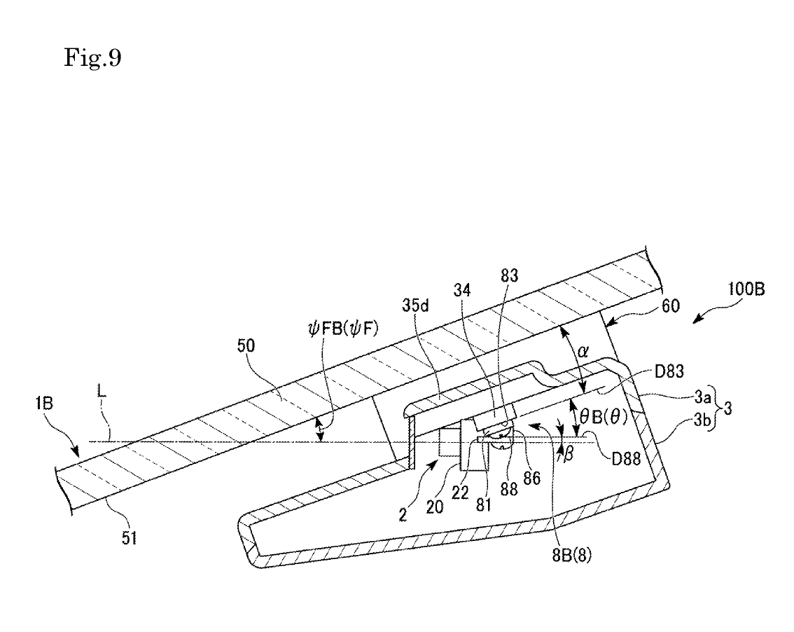

FIG. 9 is a cross-sectional view of a vehicle-mounted camera 100B for which positioners 8B having a positioning angle θB are selected, illustrating a state in which the vehicle-mounted camera 100B is mounted on a vehicle body 1B. The front windshield 50 of the vehicle body 1B has an inclination angle ΨB.

In the vehicle body 1A and the vehicle body 1B, the inclination angles ΨFA and ΨFB of the front windshield 50 have the relationship ΨFA>ΨFB. In addition, the positioning angles θA and θB of the positioners 8A and 8B have the relationship θA>θB.

FIGS. 8 and 9 schematically illustrate cross-sectional views for ease of understanding the relationship in terms of fixation among the camera main structure assembly 2, the positioners 8A and 8B, and the cover enclosure 3a. The views of respective members therefore differ from the actual cross-sectional views of the members.

Hereinafter, a description common to the vehicle bodies 1A and 1B will be made by regarding the vehicle bodies as a vehicle body 1, a description common to the vehicle-mounted cameras 100A and 100B will be made by regarding the vehicle-mounted cameras as a vehicle-mounted camera 100, a description common to the positioners 8A and 8B will be made by regarding the positioners as positioners 8, and a description common to the positioning angles θA and θB will be made by regarding the positioning angles as a positioning angle θ.

In addition, in the present preferred embodiment, the optical axis L is set in a horizontal direction. Accordingly, the inclination angle ΨF which is the depression angle of the glass surface 51 with respect to a horizontal plane is equal to an angle defined by the glass surface 51 and the optical axis L.

As illustrated in FIGS. 8 and 9, the direction of the enclosure-side contact plane 83 is defined as a first direction D83 in each positioner 8. The enclosure-side contact plane 83 includes a set of enclosure-side contact points at which each positioner 8 and each enclosure-side seat 34 make contact with each other. Accordingly, the first direction D83 corresponds to a direction determined by at least three enclosure-side contact points included in the enclosure-side contact plane 83.

In addition, in each positioner 8, the direction of the camera-side contact plane 88 is defined as a second direction D88. The camera-side contact plane 88 includes a set of camera-side contact points at which the positioner 8 and the camera-side seat 22 make contact with each other. Accordingly, the second direction D88 corresponds to a direction determined by at least three camera-side contact points included in the camera-side contact plane 88.

Note that in this specification, directions (first direction D83 and second direction D88) mean tilt directions in a plane including a front-back direction and a perpendicular direction (vertical direction). Likewise, an inclination angle Ψ, the positioning angle θ, and differences α and β to be described later are angles defined by directions in a plane including an front-back direction and a perpendicular direction (vertical direction).

As illustrated in FIGS. 8 and 9, the first direction D83 and the direction of the glass surface 51 are set with the angular difference α therebetween. The difference α is an angle determined by the position of the enclosure-side seat surface 34a of the cover enclosure 3a with respect to the glass surface 51 (see FIG. 4). Accordingly, the difference α remains unchanged no matter what type of vehicle the vehicle-mounted camera is mounted on, as long as the configurations of the cover enclosure 3a and the mounting member 60 are not changed. In the present preferred embodiment, the enclosure-side seat surface 34a is parallel to the glass surface 51 in each of the vehicle-mounted cameras 100A and 100B, and therefore, the difference α is 0° or about 0°.

As illustrated in FIGS. 8 and 9, the second direction D88 and the direction of the optical axis L are set with the angular difference β therebetween. The difference β is an angle determined by the positional relationship between the optical axis L and the camera-side seat surface 22a of the camera main structure assembly 2 (see FIG. 4). Accordingly, the difference β remains unchanged no matter what type of vehicle the vehicle-mounted camera is mounted on, as long as the configuration of the camera main structure assembly 2 is not changed. In the present preferred embodiment, the second direction D88 is parallel to the direction of the optical axis L in each of the vehicle-mounted cameras 100A and 100B, and therefore, the difference β is 0° or about 0°.

The positioning angle θ is the difference between the first direction D83 and the second direction D88 in each positioner 8. The tilt component of the optical axis L of the camera main structure assembly 2 with respect to the glass surface 51 is represented by a sum of the difference α, the difference β and the positioning angle θ. That is, the inclination angle ΨF, the positioning angle θ, the difference α, and the difference β have the following relationship (Expression 1).

ΨF=α+β+θ (Expression 1)

Note that in Expression 1, the difference α, the difference β and the positioning angle θ respectively have positive and negative values. The difference α is the angle between the first direction D83 and the direction of the glass surface 51, where the angle, when defined in the clockwise direction, is defined as a positive angle in FIGS. 8 and 9. The difference β is the angle between the direction of the optical axis L and the second direction D88, where the angle, when defined in the clockwise direction, is defined as a positive angle in FIGS. 8 and 9. Likewise, the positioning angle θ is the angle between the second direction D88 and the first direction D83, where the angle, when defined in the clockwise direction, is defined as a positive angle in FIGS. 8 and 9.

Expression 1 can be transformed into the following expression (Expression 2):

θ=ΨF−α−β (Expression 2)

The difference α is an angle dependent on the attachment position of the camera on the glass surface 51 of the cover enclosure 3a and is a constant in the present preferred embodiment. Likewise, the difference β is an angle dependent on the configuration of each constituent element of the camera main structure assembly 2 and is a constant in the present preferred embodiment.

In contrast, the positioning angle θ can be changed by selecting the positioners 8 to direct the optical axis L at a preferred direction. Positioners 8 having a positioning angle θ closest to the preferred positioning angle θ calculated according to Expression 2 are selected and attached to the vehicle-mounted camera 100. Consequently, the vehicle-mounted camera 100 is able to be mounted on the vehicle body 1 with the optical axis L set to within the tolerable direction range LR (see FIG. 1).

Note that in the present preferred embodiment, both of the difference α and the difference β are 0° in each of the examples illustrated in FIGS. 8 and 9. Accordingly, from Expression 2, it is most preferable to select positioners 8 having the positioning angle θ of which corresponds to the inclination angle ΨF of the glass surface 51.

As described above, the positioning angle θ (θA or θB) is selected by a predetermined method of referring to the inclination angle ΨF (ΨFA or ΨFB), the difference α and the difference β of the glass surface 51 determined according to a type of vehicle.

Note that although a method of selecting the preferred positioning angle θ according to Expression 2 described above has been cited here as an example of the “predetermined method” of selecting the positioning angle θ, any other desirable method may be applied as the “predetermined method.” For example, according to Expression 2, options of the inclination angle ΨF of the glass surface 51 and the types of positioners 8 having a positioning angle θ selectable for the inclination angle ΨF may be prepared in advance in the form of a select table. In this case, selecting the positioning angle θ by referring to the table corresponds to the “predetermined method.” Alternatively, if the inclination angle ΨF of the glass surface 51 has been determined for each type of vehicle, options of the type of vehicle and the types of positioners 8 having a positioning angle θ selectable for the type of vehicle may be prepared in the form of a select table.

Next, a description will be provided of a method of manufacturing the vehicle body 1 on which the vehicle-mounted camera 100 is mounted. Note that the method of manufacturing the vehicle body 1 to be described here includes calibration of the vehicle-mounted camera 100 performed after the camera is mounted on the vehicle body 1.

First, the vehicle-mounted camera 100 and the vehicle body 1 on which the vehicle-mounted camera 100 is to be mounted are prepared. In addition, the positioners 8 of the prepared vehicle-mounted camera 100 are previously selected in conformity with the inclination angle ΨF of the front windshield 50 of the vehicle body 1.

Note that two or more types of vehicle-mounted cameras 100 each of which has one of a plurality of positioning angles θ may be prepared. For example, a vehicle-mounted camera 100A including positioners 8A having a positioning angle θA (see FIG. 8) and a vehicle-mounted camera 100B including positioners 8B having a positioning angle θB (see FIG. 9) may be prepared in advance. In this case, a vehicle-mounted camera having a positioning angle θ selected by a predetermined method can be selected from the previously prepared two or more types of vehicle-mounted cameras 100A and 100B. Here, as the predetermined method, it is possible to adopt, for example, a method of calculating a preferred positioning angle θ from the inclination angle ΨF, the difference α and the difference β of the front windshield 50 of the vehicle body 1 according to Expression 2, as described above.

Next, the vehicle-mounted camera 100 is mounted on the vehicle body 1.

A mounting member 60 is preferably used to mount the vehicle-mounted camera 100 on the vehicle body 1, as illustrated in FIGS. 6 and 7.

Next, directional adjustment of the vehicle-mounted camera 100 is performed. Here, the directional adjustment refers to the calibration of the vehicle-mounted camera 100 by electronic processing.

As illustrated in FIG. 1, the optical axis L of the vehicle-mounted camera 100 falls within the tolerable direction range LR. Accordingly, the optical axis L of the vehicle-mounted camera 100 may have a deviation within the tolerable direction range LR from the most preferred direction of the optical-axis. In addition, there may arise a deviation from the optical axis L set based on design values due to assembly errors in an assembly process of the vehicle-mounted camera 100. The vehicle-mounted camera 100 of the present preferred embodiment can be calibrated against a deviation from the most preferred direction of the optical-axis by using electronic processing.

The processor circuit 4 mounted on the processor board 5 of the vehicle-mounted camera 100 includes an image processing program that uses a direction error when images captured by the camera main structure assembly 2 are processed. The image processing program electronically shifts the images captured by the camera main structure assembly 2 to correct the deviation of the direction of the optical-axis. The amount of correction is previously calculated on the basis of the actual inclination angle of the front windshield 50 and the selected positioning angle θ and stored in the processor circuit 4.

In the directional adjustment, an image of a target object positioned in a known direction with respect to the targeted vehicle body 1 is captured by the camera main structure assembly 2 of the vehicle-mounted camera 100 after the camera is attached to the glass surface 51 of the targeted vehicle body 1, and the processor circuit 4 acquires the image. Thus, the processor circuit 4 recognizes an on-image position which is the position of the target object on the image. On the other hand, the processor circuit 4 recognizes an original position, which is the position where the target object should originally be located on the image, on the basis of the known direction. Then, the processor circuit 4 calculates a direction error using the original position and the on-image position. In addition, the calculated direction error is recorded in a form usable by the image processing program.

As described above, the direction error in the vehicle-mounted camera is able to be reduced by performing the directional adjustment.

As an alternative preferred embodiment of a method, a dedicated optical target may be set up in a predetermined place ahead of the vehicle to make the vehicle-mounted camera 100 capture an image of the target after the vehicle-mounted camera 100 is attached to the front windshield 50. Then, the processor circuit 4 may calculate the amount of correction on the basis of the difference between the position of the optical target on the image and the actual position of the target to perform correction processing.

Adopting this alternative preferred embodiment of a method also enables the correction of a mounting direction error which may arise in the attachment process of the vehicle-mounted camera 100 to the front windshield 50.

Note that a case has been discussed here in which the directional adjustment of the vehicle-mounted camera 100 is performed by electronic processing in the processor circuit 4 of the vehicle-mounted camera 100. Alternatively, the directional adjustment of the vehicle-mounted camera 100 may be performed using an image processing program of external equipment connected to the vehicle-mounted camera 100.

Next, a vehicle-mounted camera 200 of Variation 1 of a preferred embodiment of the present invention will be described.

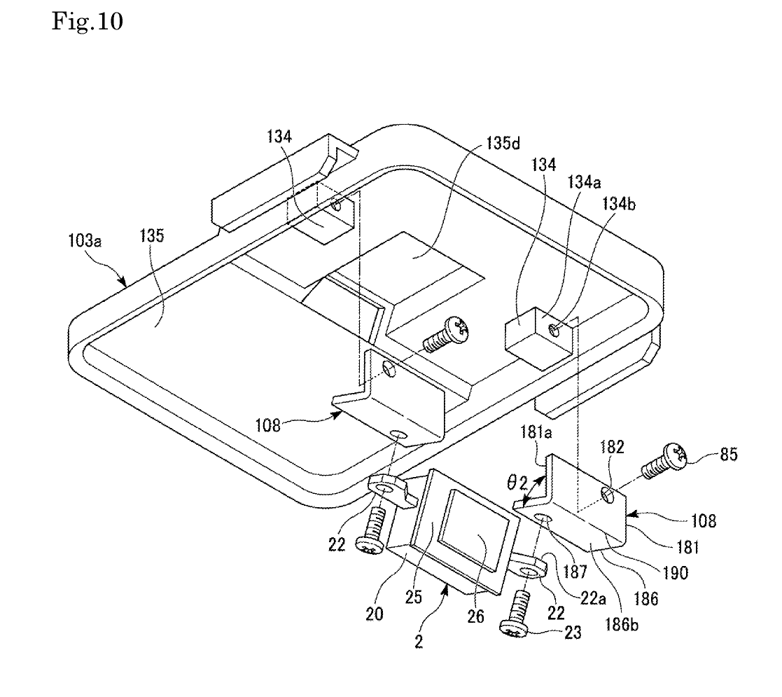

FIG. 10 is an exploded view of the vehicle-mounted camera 200. Note that in FIG. 10, a processor board and a base enclosure are excluded from the illustration.

The vehicle-mounted camera 200 is different from the above-described vehicle-mounted camera 100 mainly in terms of the configuration of positioners 108. Note that the same constituent elements as those in the above-described preferred embodiment are denoted by like reference numerals and characters and will not be described again here.

As illustrated in FIG. 10, the vehicle-mounted camera 200 of this variation includes a cover enclosure 103a, positioners 108, and a camera main structure assembly 2.

The cover enclosure 103a preferably includes a top plate 135 in which a camera housing 135d is disposed. The top plate 135 includes a pair of enclosure-side seats 134 projecting downward from the lower surface of the top plate. The pair of enclosure-side seats 134 are disposed on the right and left sides of the camera housing 135d.

The pair of enclosure-side seats 134 preferably have the same shape and size. In this variation, each enclosure-side seat 134 preferably has a quadrangular prismatic shape. The enclosure-side seat 134 includes an enclosure-side seat surface 134a facing rearward. The enclosure-side seat surface 134a is a flat surface that supports a positioner 108. A screw hole 134b used to screw-fasten the positioner 108 is preferably provided in the enclosure-side seat surface 134a.

The positioners 108 are disposed in a pair in the vehicle-mounted camera 200 to define the mounting angle of the camera main structure assembly 2 with respect to the cover enclosure 103a. As illustrated in FIG. 10, the positioners 108 preferably are L-shaped plate-shaped members.

Each positioner 108 preferably includes a plate-shaped first section 181, a plate-shaped second section 186, and a bent portion 190 connecting the first section 181 and the second section 186. Each positioner 108 is partially bent at the bent portion 190.

The first section 181 includes an enclosure-side positioner 181a which has a surface configured to make contact with the enclosure-side seat surface 134a. That is, a surface of each positioner 108 includes the enclosure-side positioner 181a. A through-hole 182 open in the enclosure-side positioner 181a is provided in the first section 181. The positioner 108 is screw-fixed to the enclosure-side seat 134 through the through-hole 182. The enclosure-side positioner 181a makes surface contact with the enclosure-side seat surface 134a of the enclosure-side seat 134.

The second section 186 includes a camera-side positioner 186b which has a surface configured to make contact with the camera-side seat surface 22a of the camera main structure assembly 2. That is, a surface of each positioner 108 includes the camera-side positioner 186b. The camera-side positioner 186b is inclined at a positioning angle θ2 with respect to the enclosure-side positioner 181a. A screw hole 187 is preferably provided in the camera-side positioner 186b. The camera-side seat 22 of the camera main structure assembly 2 is screw-fastened to the screw hole 187. Thus, the camera main structure assembly 2 is fixed to the positioner 108. The camera-side positioner 186b preferably makes surface contact with the camera-side seat surface 22a of the camera-side seat 22.

The bent portion 190 is positioned between the enclosure-side positioner 181a and the camera-side positioner 186b. The bent angle of the bent portion 190 is a positioning angle θ2 relative to the enclosure-side positioner 181a and the camera-side positioner 186b.

Note that although the bent portion 190 is preferably provided in one place of the positioner 108 in this variation, for example, the bent portion 190 may be provided in two or more places.

Each positioner 108 can be obtained by, for example, pressing a metal plate. The positioner 108 is required to have sufficient rigidity, in order to prevent deformation due to any external force, and is therefore preferably made from, for example, iron or stainless steel. Since iron or stainless steel shows less springback at the time of bending than aluminum, the positioning angle of the positioner 108 can be determined with a high degree of accuracy. In addition, a surface of at least one of the enclosure-side positioner 181a and the camera-side positioner 186b is preferably partially cut into a cut surface in the positioner 108. Consequently, it is possible to increase the accuracy of the positioning angle θ2 which is an angle defined by the enclosure-side positioner 181a and the camera-side positioner 186b. However, if the vehicle-mounted camera 200 has an electronic processing-based calibration function against a deviation from the most preferred direction of the optical-axis as is the case with the vehicle-mounted camera 100 in the preferred embodiment described earlier, cutting work may not be performed on the enclosure-side positioner 181a and the camera-side positioner 186b. The reason for this is that some accuracy degradation of the positioning angle θ2 caused by the omission of cutting work can be compensated for by electronic processing.

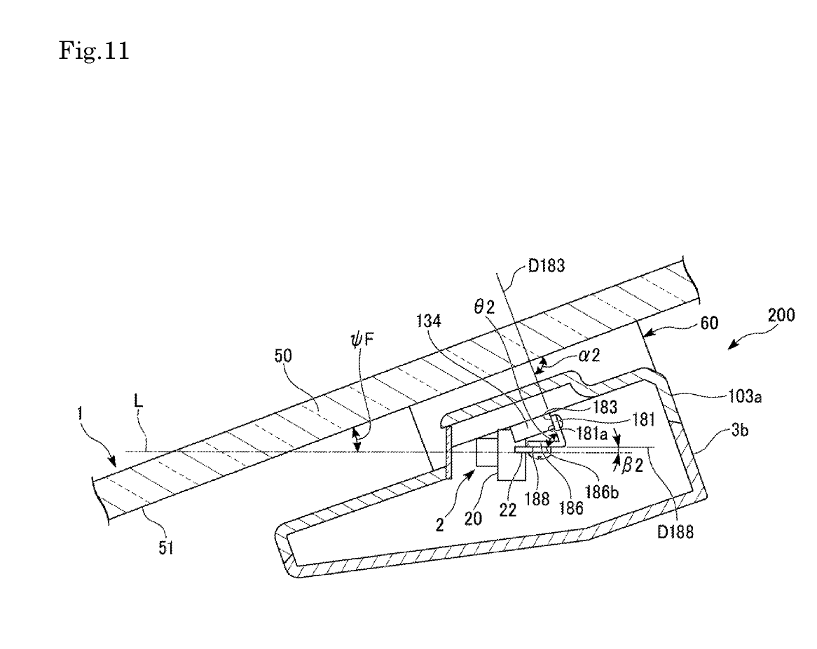

FIG. 11 is a schematic cross-sectional view of the vehicle-mounted camera 200, illustrating a state of the camera being mounted on the vehicle body 1. FIG. 11 schematically illustrates a cross-sectional view for ease of understanding the relationship in terms of fixation among the camera main structure assembly 2, the positioners 108, and the cover enclosure 103a. The views of respective members therefore differ from the actual cross-sectional views of the members.

In this variation, contact between the enclosure-side positioner 181a and the enclosure-side seat 134 is surface contact. Accordingly, the enclosure-side positioner 181a and the enclosure-side seat 134 make contact with each other at an enclosure-side contact plane 183 which includes a set of enclosure-side contact points.

Likewise, contact between the camera-side positioner 186b and the camera-side seat 22 is preferably a surface contact. Accordingly, the camera-side positioner 186b and the camera-side seat 22 make contact with each other at a camera-side contact plane 188 which includes a set of camera-side contact points.

A first direction D183 of the enclosure-side contact plane 183 is fixed as the result of the vehicle-mounted camera 200 being mounted on the vehicle body 1. A difference α2 is a difference between the first direction D183 and the direction of the glass surface 51. In this variation, the enclosure-side seat surface 134a is perpendicular or substantially perpendicular to the glass surface 51, and therefore, the difference α2 is 90° or about 90°.

In addition, the vehicle-mounted camera 200 has a difference β2 between a second direction D188 of the camera-side contact plane 188 and the direction of the optical axis L in the camera main structure assembly 2. In this variation, the second direction D188 is parallel or substantially parallel to the direction of the optical axis L, and therefore, the difference β2 is 0° or about 0°.

The positioning angle θ2 is the difference between the direction (first direction D183) of the enclosure-side contact plane 183 and the direction (second direction D188) of the camera-side contact plane 188 in each positioner 108. The positioning angle θ2 is selected by a predetermined method of referring to the inclination angle ΨF, the difference α, and the difference β of the glass surface 51 determined according to the type of vehicle. The positioning angle θ2, the inclination angle ΨF, the difference α2, and the difference β2 have the following relationship (Expression 3).

ΨF=α2+β2−θ2 (Expression 3)

Note that Expression 3 is equivalent to Expression 1 used to evaluate the positioning angle θ2 of the above-described vehicle-mounted camera 200. The value of θ2 in Expression 3 is negative unlike in the case of Expression 1 since the angular direction of the positioning angle θ2 is a negative direction.

Expression 3 can be transformed into the following expression (Expression 4):

θ2=−ΨF+α2+β2 (Expression 4)

A plurality of positioners 108 having a plurality of positioning angles θ2 are preferably prepared in advance in the assembly of the vehicle-mounted camera 200. The inclination angle ΨF of the glass surface 51 of the vehicle body 1 is determined, and positioners 108 having a positioning angle close to a preferred positioning angle θ2 calculated according to Expression 4 are selected and attached to the vehicle-mounted camera 200. Consequently, the vehicle-mounted camera 200 is able to be mounted on the vehicle body 1 with the optical axis L falling within the tolerable direction range LR (see FIG. 1).

Next, a vehicle-mounted camera 300 of Variation 2 of a preferred embodiment of the present invention is described.

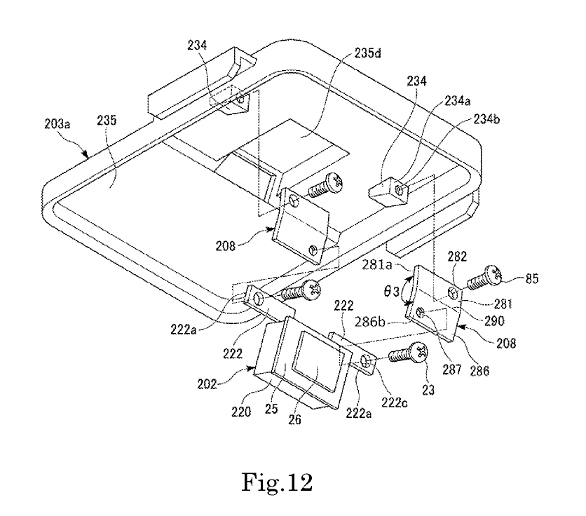

FIG. 12 is an exploded view of the vehicle-mounted camera 300. Note that in FIG. 12, a processor board and a base enclosure are excluded from the illustration.

The vehicle-mounted camera 300 is preferably different from the above-described vehicle-mounted camera 100 mainly in terms of the configuration of positioners 208. Note that the same constituent elements as those in the above-described preferred embodiments and variation are denoted by like reference numerals and characters and will not be described again here.

As illustrated in FIG. 12, the vehicle-mounted camera 300 of this variation preferably includes a cover enclosure 203a, positioners 208, and a camera main structure assembly 202.

The cover enclosure 203a preferably includes a top plate 235 in which a camera housing 235d is disposed. The top plate 235 includes a pair of enclosure-side seats 234 projecting downward from the lower surface of the top plate.

In this variation, each enclosure-side seat 234 preferably has a quadrangular prismatic shape. The enclosure-side seat 234 includes an enclosure-side seat surface 134a facing rearward. The enclosure-side seat surface 234a is inclined in a direction orthogonal to the top plate 235. A screw hole 234b that is used to screw-fasten the positioner 208 is preferably provided in the enclosure-side seat surface 234a.

The camera main structure assembly 202 preferably includes a base 220, a lens (not illustrated), an image sensor board 25, and an image sensor 26.

A pair of camera-side seats 222 are disposed in an upper portion of the base 220 and extend from both sides of the base 220 in the width direction thereof. Each camera-side seat 222 includes a camera-side seat surface 222a orthogonal to the optical axis L. A through-hole 222c open in the camera-side seat surface 222a is provided in the camera-side seat 222.

The positioners 208 are fitted on the vehicle-mounted camera 300 in a pair to define the mounting angle of the camera main structure assembly 202 with respect to the cover enclosure 203a. Each positioner 208 preferably includes a plate-shaped first section 281, a plate-shaped second section 286, and a bent portion 290 at which the positioner 208 is partially bent. The bent portion 290 connects the first section 281 and the second section 286.

The first section 281 includes an enclosure-side positioner 281a which has a surface configured to make contact with the enclosure-side seat surface 234a. A through-hole 282 open in the enclosure-side positioner 281a is provided in the first section 281, so that the first section 281 is screw-fixed to the enclosure-side seat 234.

The second section 286 preferably includes a camera-side positioner 286b which includes a surface configured to make contact with the camera-side seat surface 222a of the camera main structure assembly 202. The camera-side positioner 286b is inclined at a positioning angle θ3 with respect to the enclosure-side positioner 281a. A screw hole 287 is provided in the camera-side positioner 286b and used to screw-fasten the camera-side seat 222.

The bent portion 290 is positioned between the enclosure-side positioner 281a and the camera-side positioner 286b. The bent angle of the bent portion 290 is a positioning angle θ3 relative to the enclosure-side positioner 281a and the camera-side positioner 286b.

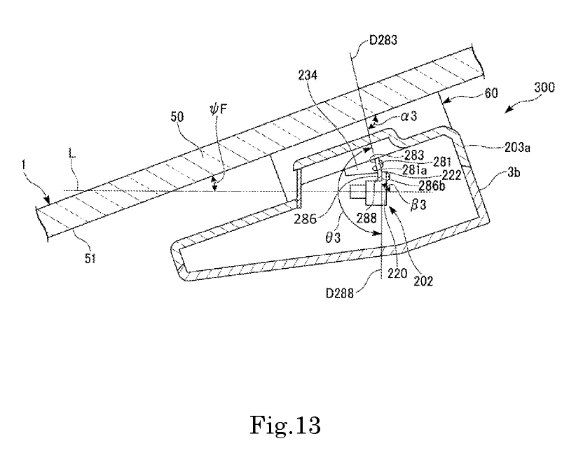

FIG. 13 is a schematic cross-sectional view of the vehicle-mounted camera 300, illustrating a state of the camera being mounted on the vehicle body 1. Note that FIG. 13 schematically illustrates a cross-sectional view for ease of understanding the relationship in terms of fixation among the camera main structure assembly 202, the positioners 208, and the cover enclosure 203a. The views of respective members therefore differ from the actual cross-sectional views of the members.

In this variation, the enclosure-side positioner 281a and the enclosure-side seat 234 make surface contact with each other, thus defining an enclosure-side contact plane 283 including enclosure-side contact points.

Likewise, the camera-side positioner 286b and the camera-side seat 222 make surface contact with each other, thus defining a camera-side contact plane 288 including camera-side contact points.

The first direction D283 of the enclosure-side contact plane 283 is fixed as the result of the vehicle-mounted camera 300 being mounted on the vehicle body 1. The first direction D283 creates a difference α3 from the direction of the glass surface 51. In addition, the vehicle-mounted camera 300 has a difference β3 between the second direction D288 of the camera-side contact plane 288 and the direction of the optical axis L in the camera main structure assembly 202. In this variation, the second direction D288 is perpendicular or substantially perpendicular to the direction of the optical axis L, and therefore, the difference β3 is 90° or about 90°.

The positioning angle θ3 is the difference between the direction (first direction D283) of the enclosure-side contact plane 283 and the direction (second direction D288) of the camera-side contact plane 288 in each positioner 208. The positioning angle θ3 is selected by a predetermined method of referring to the inclination angle ΨF, the difference α3, and the difference β3 of the glass surface 51 determined according to the type of vehicle. The positioning angle θ3, the inclination angle ΨF, the difference α3, and the difference β3 have the following relationship (Expression 5).

ΨF=α3+β3−θ3 (Expression 5)

Expression 5 can be transformed into Expression 6 shown below:

θ3=−ΨF+α3+β3 (Expression 6)

A plurality of positioners 208 having a plurality of positioning angles θ3 are prepared in advance in the assembly of the vehicle-mounted camera 300. The inclination angle ΨF of the glass surface 51 of the vehicle body 1 is determined, and positioners 208 having a positioning angle close to a preferred positioning angle θ3 calculated according to Expression 6 are selected and attached to the vehicle-mounted camera 300. Consequently, the vehicle-mounted camera 300 can be mounted on the vehicle body 1 with the optical axis L falling within the tolerable direction range LR (see FIG. 1).

Next, a vehicle-mounted camera 400 of Variation 3 of a preferred embodiment of the present invention will be described.

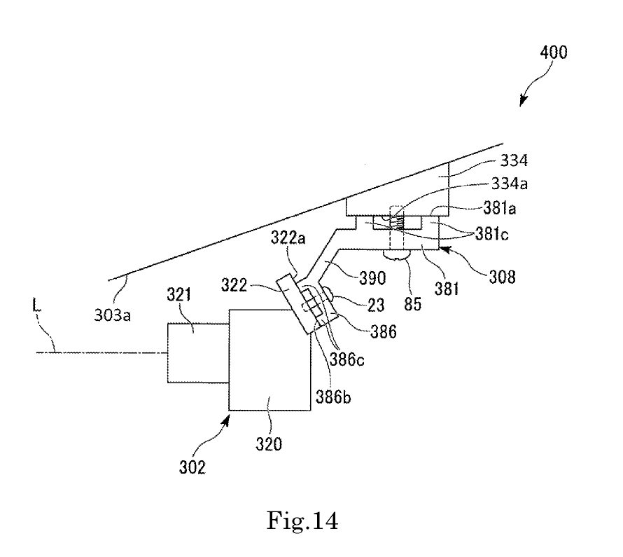

FIG. 14 is a partial schematic view of the vehicle-mounted camera 400.

The vehicle-mounted camera 400 is different from the above-described vehicle-mounted camera 100 mainly in terms of the configuration of positioners 308. Note that the same constituent elements as those in the above-described preferred embodiments and variations are denoted by like reference numerals and characters and will not be described again here.

As illustrated in FIG. 14, the vehicle-mounted camera 400 of this variation preferably includes a positioner 308, a camera main structure assembly 302, and a cover enclosure 303a which is the same type of cover enclosure as that of the above-described vehicle-mounted camera 100.

The camera main structure assembly 302 preferably includes a base 320, a lens 321, an image sensor board, and an image sensor. (The image sensor board and the image sensor are not shown in FIG. 14.)

A pair of camera-side seats 322 are disposed in an upper portion of the base 320. Each camera-side seat 322 includes a camera-side seat surface 322a inclined with respect to the optical axis L.

The positioner 308 of this variation preferably includes a first block 381, a second block 386, and a connecting portion 390.

The first block 381 preferably includes a pair of enclosure-side protruding areas 381c extending in the width direction of the vehicle-mounted camera 400 and projecting toward the enclosure-side seat surface 334a. An enclosure-side positioner 381a which has a flat surface is disposed at the leading end of each enclosure-side protruding area 381c. The first block 381 is preferably screw-fastened to the enclosure-side seat 334 with a screw 85. The screw 85 is positioned between the pair of enclosure-side protruding areas 381c.

Likewise, the second block 386 preferably includes a pair of camera-side protruding areas 386c extending in the width direction of the vehicle-mounted camera 400 and projecting toward the camera-side seat surface 322a. A camera-side positioner 386b having a flat surface is disposed at the leading end of each camera-side protruding area 386c. The second block 386 is screw-fastened to the camera-side seat 322 with a screw 23. The screw 23 is positioned between the pair of camera-side protruding areas 386c.

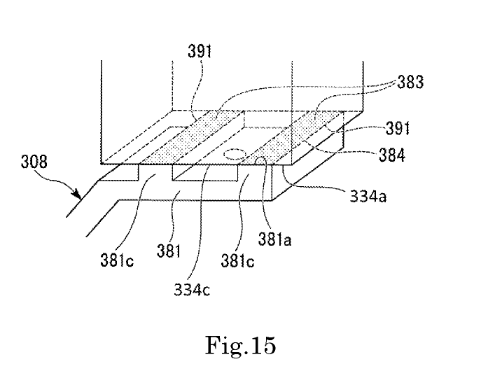

FIG. 15 is a perspective view taken by enlarging a fixed portion between the positioner 308 and the cover enclosure 303a. Here, the enclosure-side fixed portion of the positioner 308 will be described by referring to FIG. 15.

Note that the configuration of the fixed portion (camera-side fixed portion) between the positioner 308 and the camera main structure assembly 302 is the same as that of the enclosure-side fixed portion, and therefore, will not be described here.

As illustrated in FIG. 15, the pair of enclosure-side positioners 381a of the positioner 308 and the enclosure-side seats 334 of the cover enclosure 303a make surface contact with each other, thus defining a pair of enclosure-side contact planes 383 including enclosure-side contact points. Each of the pair of enclosure-side contact planes 383 defines an external rectangular shape. Each enclosure-side contact plane 383 is surrounded by four first edges 391. Two of the four first edges 391 originate from the edge portion 384 of the enclosure-side positioner 381a. In addition, the other two of the four first edges 391 are preferably provided by overlapping of the edge portion 334c of the enclosure-side seat surface 334a of the enclosure-side seat 334 and the edge portion 384 of the enclosure-side positioner 381a.

At least one (both, in this variation) of the enclosure-side seat 334 and the enclosure-side positioner 381a includes the first edge 391 configured to make contact with the other one, and at least one of enclosure-side contact points is positioned on the first edge 391. As the result of applying such a configuration as described above, the positioner 308 and the enclosure-side seat 334 make contact with each other at the first edge 391 even if contact between the positioner 308 and the enclosure-side seat 334 is not surface contact, and the enclosure-side seat 334 can stably support the positioner 308.

Next, a vehicle-mounted camera 500 of Variation 4 of a preferred embodiment of the present invention will be described.

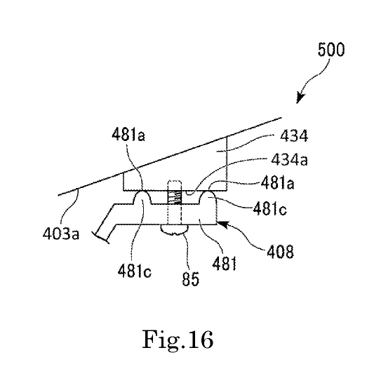

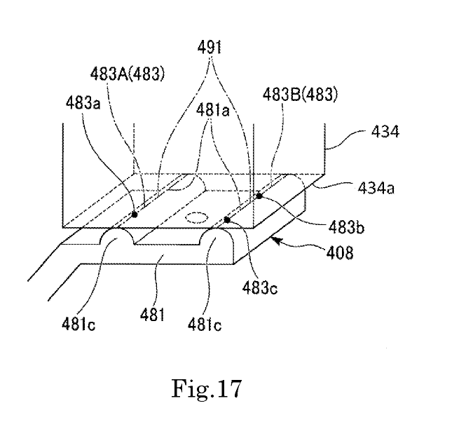

FIG. 16 is a partial schematic view of the vehicle-mounted camera 500. FIG. 17 is a perspective view taken by enlarging the fixed portion between a positioner 408 of the vehicle-mounted camera 500 and the cover enclosure 403a.

The vehicle-mounted camera 500 preferably has a configuration similar to that of the above-described vehicle-mounted camera 400 of Variation 3, but the configurations of the positioners 408 of both vehicle-mounted cameras 400 and 500 are different from each other. The positioner 408 of Variation 4 is different from the positioner 308 of Variation 3 in terms of the configuration of the enclosure-side positioner 481a. Note that the same constituent elements as those in the above-described preferred embodiments and variations are denoted by like reference numerals and characters and will not be described again here.

As illustrated in FIGS. 16 and 17, the positioner 408 of this variation preferably includes a first block 481 used to fix the positioner to the cover enclosure 434a. In addition, the positioner 408 preferably includes a connecting portion and a second block having the same configurations as those of the above-described positioner 308 of Variation 3, which will not be described here.

The first block 481 includes a pair of enclosure-side protruding areas 481c extending in the width direction of the vehicle-mounted camera 500 and projecting toward the enclosure-side seat surface 434a. In this variation, a cross section of the enclosure-side protruding area 481c orthogonal to the width direction thereof is semicircular. As illustrated in FIG. 16, a screw 85 used to screw-fasten the first block 481 to the enclosure-side seat 434 is disposed between the pair of enclosure-side protruding areas 481c.

As illustrated in FIG. 17, an enclosure-side positioner 481a configured to make contact with the enclosure-side seat surface 434a is disposed at the leading end of each enclosure-side protruding areas 481c. Since the leading end of the enclosure-side protruding area 481c includes a curved surface, contact between the positioner 408 and the enclosure-side seat 434 is line contact. Accordingly, the enclosure-side positioner 481a is a straight line extending in the width direction.

The pair of enclosure-side positioners 481a of the positioner 408 and the enclosure-side seats 434 of the cover enclosure 434a make line contact with each other respectively, thus defining a pair of enclosure-side contact lines 483.

Each of the pair of enclosure-side contact lines 483 includes a set of contact points (enclosure-side contact points). As the result of one of the enclosure-side contact points being disposed in a position deviated from a straight line passing through other two points, the degree of freedom of each enclosure-side positioner 481a with respect to the enclosure-side seat 434 is able to be reduced to zero. In this variation, one enclosure-side contact point 483a is selected from one enclosure-side contact line 483A of the pair of enclosure-side contact lines 483, and two enclosure-side contact points 483b and 483c are selected from the other enclosure-side contact line 483B. In this case, the three enclosure-side contact points 483a, 483b and 483c do not align on the same straight line. Thus, according to this variation, the positioner 408 is stably supported on the enclosure-side seat 434.

Also in this variation, the enclosure-side seat 434 makes contact with the enclosure-side positioners 481a at the enclosure-side contact lines 483, thus defining first edges 491. That is, each enclosure-side positioner 481a includes a first edge 491 configured to make contact with the enclosure-side seat 434. In addition, since each enclosure-side contact line 483 including a set of enclosure-side contact points, at least one of the enclosure-side contact points is positioned on the first edge 491. By applying such a configuration as described above, the positioner 408 and the enclosure-side seat 434 are brought into contact with each other at the first edges 491, thus allowing the enclosure-side seat 434 to stably support the positioner 408.

Note that in this variation, the cross-sectional shape of each enclosure-side protruding area 481c is not limited to a semicircular shape. Each enclosure-side protruding area 481c may have any cross-sectional shape, as long as the protruding area 481c defines the first edge 491 making contact with the enclosure-side seat 434 and extending in the width direction thereof. Accordingly, the enclosure-side protruding area 481c may have, for example, an inverted V-shape.

Next, a vehicle-mounted camera 600 of Variation 5 of a preferred embodiment of the present invention will be described.

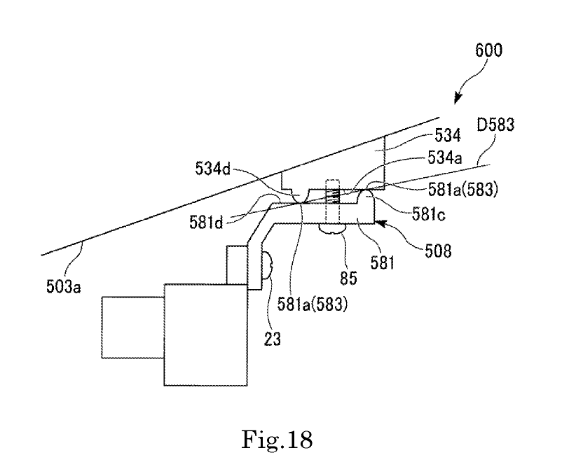

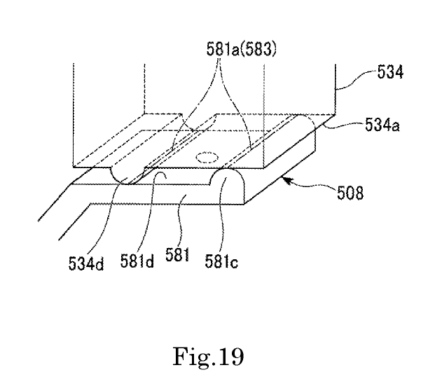

FIG. 18 is a partial schematic view of the vehicle-mounted camera 600. FIG. 19 is a perspective view taken by enlarging the fixed portion between a positioner 508 of the vehicle-mounted camera 600 and a cover enclosure 503a.

The vehicle-mounted camera 600 preferably has a configuration similar to that of the above-described vehicle-mounted cameras 400 and 500 of Variations 3 and 4, but the configurations of an enclosure-side seat 534 of the cover enclosure 503a and the positioner 508 are different from each other. Note that the same constituent elements as those in the above-described preferred embodiments and variations are denoted by like reference numerals and characters and will not be described again here.

The positioner 508 of this variation preferably includes a first block 581 used to fix the positioner to the cover enclosure 503a. In addition, the positioner 508 preferably includes a connecting portion and a second block having the same configurations as those of the above-described positioner 308 of Variation 3, which will not be described here.

The first block 581 preferably includes a mounting surface 581d which is a flat surface facing upward. In addition, an enclosure-side protruding area 581c extending in the width direction of the vehicle-mounted camera 600 and projecting toward the enclosure-side seat surface 534a is disposed on the mounting surface 581d. A cross section of the enclosure-side protruding area 581c orthogonal to the width direction thereof is preferably semicircular.

Likewise, the enclosure-side seat 534 of the cover enclosure 503a includes an enclosure-side seat surface 534a. The enclosure-side seat surface 534a is a flat surface. In addition, a downward-protruding area 534d extending in the width direction of the vehicle-mounted camera 600 and projecting downward is disposed on the enclosure-side seat surface 534a. A cross section of the downward-protruding area 534d orthogonal to the width direction thereof is preferably semicircular.

The enclosure-side protruding area 581c of the first block 581 and the downward-protruding area 534d of the enclosure-side seat 534 extend in parallel or substantially in parallel with each other. In addition, the enclosure-side protruding area 581c and the downward-protruding area 534d are disposed while being shifted from each other in the front-back direction of the positioner 508.

The enclosure-side protruding area 581c makes line contact with the enclosure-side seat surface 534a. Likewise, the downward-protruding area 534d makes line contact with the mounting surface 581d. The two contact lines define enclosure-side positioners 581a between the enclosure-side seat 534 and the positioner 508. The enclosure-side positioners 581a of this variation are a pair of straight lines.

In addition, the pair of straight-line enclosure-side positioners 581a preferably define a pair of enclosure-side contact lines 583 which include a set of contact points (enclosure-side contact points). One enclosure-side contact point is selected from one of the pair of enclosure-side contact lines 583, and two enclosure-side contact points are selected from the other enclosure-side contact line 583. Consequently, the three enclosure-side contact points do not align on the same straight line. Thus, according to this variation, the positioner 508 is stably supported on the enclosure-side seat 534. In addition, in this variation, each first direction D583 which is determined by at least three enclosure-side contact points corresponds to a direction of a line connecting the pair of enclosure-side contact lines 583, as illustrated in FIG. 18.

Note that the cross-sectional shapes of the enclosure-side protruding area 581c and the downward-protruding area 534d of this variation are not limited to a semicircular shape, as in the case of Variation 4.

Next, a vehicle-mounted camera 700 of Variation 6 of a preferred embodiment of the present invention will be described.

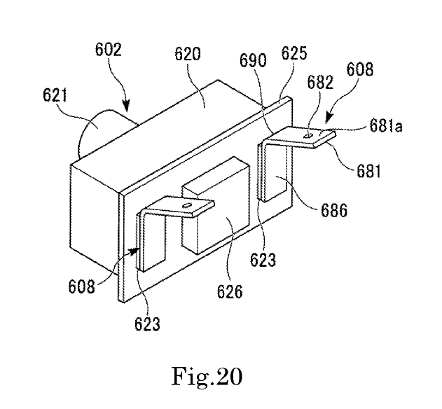

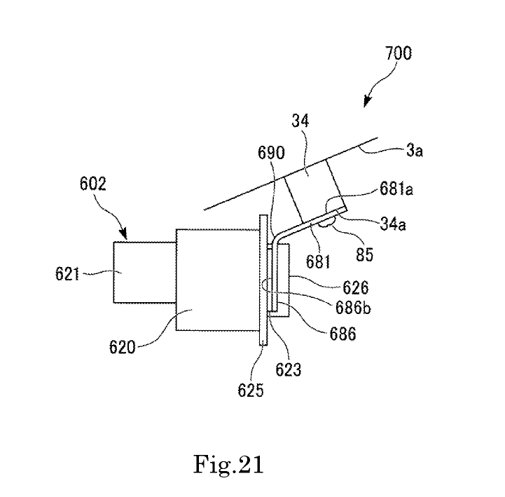

FIG. 20 is a perspective view illustrating a camera main structure assembly 602 and a positioner 608 in this variation. FIG. 21 is a partial schematic view of the vehicle-mounted camera 700.

The camera main structure assembly 602 of this variation preferably includes a lens 621, a base 620 supporting the lens 621, an image sensor 626, and an image sensor board 625 on which the image sensor 626 is mounted.

The positioner 608 preferably includes a plate-shaped first section 681, a plate-shaped second section 686, and a bent portion 690 connecting the first section 681 and the second section 686. The bent portion 690 is bent at a predetermined positioning angle θ.

The positioner 608 is preferably made from a metal material. In particular, the positioner 608 is preferably made from, for example, iron or stainless steel, both having high rigidity, in order to increase positioning accuracy.

The first section 681 includes an enclosure-side positioner 681a which has a surface configured to make contact with the enclosure-side seat surface 34a. A through-hole 682 open in the enclosure-side positioner 681a is provided in the first section 681, so that the first section 681 is screw-fixed to the enclosure-side seat 34.

The second section 686 preferably includes a camera-side positioner 686b which has a surface to be fixed on the image sensor board 625 of the camera main structure assembly 602. Solder 623 is placed between the camera-side positioner 686b and the image sensor board 625. The positioner 608 is solder-fixed on the image sensor board 625 at the camera-side positioner 686b.

Note that if stainless steel is used as the material of the positioner 608, it is preferable to use solder for stainless steel as the solder 623.

In the vehicle-mounted camera 700 of this variation, the positioner 608 is fixed on the image sensor board 625. Consequently, the camera main structure assembly 602 and the positioner 608 are able to be directly fixed together, thus enabling a reduction in the number of components.

In addition, according to the vehicle-mounted camera 700 of this variation, the positioner 608 and the image sensor board 625 are preferably fixed together by the solder 623. Consequently, heat generated in the image sensor 626 and the image sensor board 625 is released to the cover enclosure 3a through the solder 623 and the positioner 608. Note that the positioner 608 and the image sensor board 625 may be fixed together by any other fixing elements, such as, for example, screw fixation, and the solder 623 for heat transfer may be located between the positioner 608 and the image sensor board 625. In addition, even more efficient heat release from the image sensor board 625 through the positioner 608 is possible by making the cover enclosure 3a from aluminum or an aluminum alloy in this variation.

Having thus described the preferred embodiments and variations of the present invention, constituent structural elements, combinations thereof, and the like in the preferred embodiments and the variations are illustrative only. Accordingly, configurational additions, omissions, substitutions, and other modifications are possible without departing from the gist of the present invention. In addition, the present invention is not limited by the preferred embodiments.

For example, at least three enclosure-side contact points may be disposed on a curved plane in the preferred embodiments and variations. That is, the contact plane (enclosure-side contact plane) between a positioner and an enclosure-side seat may be a curved plane. In this case, a direction (first direction) determined by enclosure-side contact points can be defined as the direction of a plane formed within the enclosure-side contact plane by the at least three enclosure-side contact points which do not align in a linear manner.

Likewise, at least three camera-side contact points may be disposed on a curved plane. That is, the contact plane (camera-side contact plane) between a positioner and a camera-side seat may be a curved plane. In this case, a direction (second direction) determined by camera-side contact points can be defined as the direction of a plane formed within the camera-side contact plane by the at least three camera-side contact points which do not align in a linear manner.

In addition, positioners, enclosure-side seats and camera-side seats are not limited in position, shape and number, as long as a camera main structure assembly can be fixed to a cover enclosure. For example, there may be one positioner, one enclosure-side seat, and one camera-side seats or there may be three or more positioners, enclosure-side seats, and camera-side seats. Further, an enclosure-side seat need not necessarily have a pillar shape projecting downward from a top plate. For example, if the top plate is sufficiently thick, the top plate may be partially excavated to form a recess and the bottom surface of the recess may be used as an enclosure-side seat surface.

Still further, in the preferred embodiments and variations, examples have been cited in which a positioner and a cover enclosure are screw-fixed together in one place and the positioner and a camera main structure assembly are also screw-fixed together in one place. However, the positioner may be fixed together with the cover enclosure and the camera main structure assembly in two or more places for the purpose of preventing each fixed portion from rotating within a contact plane.

Furthermore, in the preferred embodiments and variations, a case has been described in which a cover enclosure and a base enclosure are made from aluminum or an aluminum alloy. However, the cover enclosure and the base enclosure may be made from another metal material or a resin material. Likewise, a positioner may be made from a metal material other than iron or stainless alloy, or a resin material.

The vehicle-mounted cameras of the above-described preferred embodiments and variations may be equipped with other vehicle-mounted devices, such as a rain sensor, a millimeter-wave radar sensor, and a laser radar sensor.

It is also possible to adopt a configuration in which the lens of a camera main structure assembly projects outward from the viewing window of a cover enclosure.

In addition, the shape, the position, the orientation, and the number of each of enclosure-side seats and camera-side seats are not limited to the above-described preferred embodiments and variations. Yet additionally, an enclosure-side seat may be disposed in a base enclosure.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method of manufacturing a vehicle-mounted camera including a cover enclosure including a top plate and a camera main structure assembly fixed to the cover enclosure via a positioner, the vehicle-mounted camera being attached to a glass surface of a windshield inside a vehicle at the top plate and facing forward or rearward of a vehicle body in a position in which the vehicle-mounted camera extends along the windshield, and the vehicle-mounted camera is positioned to capture an image of a scene on a front or back side of the vehicle body, the method comprising:
previously assuming a plurality of inclination angles as inclination angles of the glass surface;
previously assuming a plurality of positioning angles less than a number of the plurality of inclination angles;
determining an inclination angle of the glass surface of the vehicle body on which the vehicle-mounted camera is to be mounted;
selecting at least one positioning angle from the previously assumed plurality of positioning angles to prepare a positioner with the selected positioning angle; and
fixing the camera main structure assembly and the selected positioner to the cover enclosure; wherein
the camera main structure assembly includes a lens and an image sensor;
the top plate of the cover enclosure includes an enclosure-side seat;
the camera main structure assembly includes a camera-side seat on a surface of the camera main structure assembly;
a surface of the positioner includes an enclosure-side positioner that contacts with the enclosure-side seat at at least three enclosure-side contact points, and a camera-side positioner that contacts with the camera-side seat at at least three enclosure-side contact points;
at least one of the at least three enclosure-side contact points is located in a position deviated from a straight line passing through the other two points;
at least one of the at least three camera-side contact points is located in a position deviated from a straight line passing through the other two points;
the positioning angle is a difference between a direction determined by the at least three enclosure-side contact points and a direction determined by the at least three camera-side contact points; and
the positioning angle is selected by a predetermined method of referring to the determined inclination angle of the glass surface, a difference between the direction determined by the at least three enclosure-side contact points and a direction of the glass surface, and a difference between the direction determined by the at least three camera-side contact points and a direction of an optical axis of the camera main structure assembly.

2. The method of manufacturing a vehicle-mounted camera according to claim 1, wherein at a time of preparing the positioner having the selected positioning angle, a plurality of positioning angles are selected, a plurality of types of positioners respectively having one of the plurality of positioning angles are prepared, and one type of positioner is selected from the plurality of types of positioners.

3. The method of manufacturing a vehicle-mounted camera according to claim 1, wherein at least one of the enclosure-side seat and the enclosure-side positioner includes a first edge that contacts with the other one or at least one of the camera-side seat and the camera-side positioner includes a second edge that contacts with the other one, and at least one of enclosure-side contact points is positioned on the first edge or at least one of camera-side contact points is positioned on the second edge.

4. The method of manufacturing a vehicle-mounted camera according to claim 2, wherein at least one of the enclosure-side seat and the enclosure-side positioner includes a first edge that contacts with the other one, or at least one of the camera-side seat and the camera-side positioner includes a second edge that contacts with the other one, and at least one of the enclosure-side contact points is positioned on the first edge or at least one of the camera-side contact points is positioned on the second edge.

5. The method of manufacturing a vehicle-mounted camera according to claim 1, wherein at least one of the enclosure-side positioner and the camera-side positioner includes a cut surface formed by cutting off a portion of a surface of the at least one of the enclosure-side positioner and the camera-side positioner.

6. The method of manufacturing a vehicle-mounted camera according to claim 2, wherein at least one of the enclosure-side positioner and the camera-side positioner includes a cut surface formed by cutting off a portion of a surface of the at least one of the enclosure-side positioner and the camera-side positioner.

7. The method of manufacturing a vehicle-mounted camera according to claim 3, wherein at least one of the enclosure-side positioner and the camera-side positioner includes a cut surface formed by cutting off a portion of a surface of the at least one of the enclosure-side positioner and the camera-side positioner.

8. The method of manufacturing a vehicle-mounted camera according to claim 4, wherein at least one of the enclosure-side positioner and the camera-side positioner includes a cut surface formed by cutting off a portion of a surface of the at least one of the enclosure-side positioner and the camera-side positioner.

9. The method of manufacturing a vehicle-mounted camera according to claim 1, wherein the positioner includes a plate-shaped member and includes a bent portion at which the positioner is partially bent, and the bent portion is positioned between the enclosure-side positioner and the camera-side positioner.

10. The method of manufacturing a vehicle-mounted camera according to claim 2, wherein the positioner includes a plate-shaped member and includes a bent portion at which the positioner is partially bent, and the bent portion is positioned between the enclosure-side positioner and the camera-side positioner.

11. The method of manufacturing a vehicle-mounted camera according to claim 3, wherein the positioner includes a plate-shaped member and includes a bent portion at which the positioner is partially bent, and the bent portion is positioned between the enclosure-side positioner and the camera-side positioner.

12. The method of manufacturing a vehicle-mounted camera according to claim 4, wherein the positioner includes a plate-shaped member and includes a bent portion at which the positioner is partially bent, and the bent portion is positioned between the enclosure-side positioner and the camera-side positioner.

13. The method of manufacturing a vehicle-mounted camera according to claim 8, wherein the positioner includes a plate-shaped member and includes a bent portion at which the positioner is partially bent, and the bent portion is positioned between the enclosure-side positioner and the camera-side positioner.

14. The method of manufacturing a vehicle-mounted camera according to claim 1, wherein the cover enclosure is made from aluminum or an aluminum alloy, and the positioner is made from iron or stainless steel.

15. The method of manufacturing a vehicle-mounted camera according to claim 2, wherein the cover enclosure is made from aluminum or an aluminum alloy, and the positioner is made from iron or stainless steel.

16. The method of manufacturing a vehicle-mounted camera according to claim 4, wherein the cover enclosure is made from aluminum or an aluminum alloy, and the positioner is made from iron or stainless steel.

17. The method of manufacturing a vehicle-mounted camera according to claim 7, wherein the cover enclosure is made from aluminum or an aluminum alloy, and the positioner is made from iron or stainless steel.

18. The method of manufacturing a vehicle-mounted camera according to claim 8, wherein the cover enclosure is made from aluminum or an aluminum alloy, and the positioner is made from iron or stainless steel.

19. The method of manufacturing a vehicle-mounted camera according to claim 13, wherein the cover enclosure is made from aluminum or an aluminum alloy, and the positioner is made from iron or stainless steel.

20. The method of manufacturing a vehicle-mounted camera according to claim 1, wherein the camera-side seat includes a portion extending in a direction away from the optical axis.

21. The method of manufacturing a vehicle-mounted camera according to claim 2, wherein the camera-side seat includes a portion extending in a direction away from the optical axis.

22. The method of manufacturing a vehicle-mounted camera according to claim 3, wherein the camera-side seat includes a portion extending in a direction away from the optical axis.

23. The method of manufacturing a vehicle-mounted camera according to claim 4, wherein the camera-side seat includes a portion extending in a direction away from the optical axis.

24. The method of manufacturing a vehicle-mounted camera according to claim 19, wherein the camera-side seat includes a portion extending in a direction away from the optical axis.

25. The method of manufacturing a vehicle-mounted camera according to claim 1, wherein the camera main structure assembly further includes an image sensor board on which the image sensor is mounted, and the positioner is fixed to the image sensor board.

26. The method of manufacturing a vehicle-mounted camera according to claim 2, wherein the camera main structure assembly further includes an image sensor board on which the image sensor is mounted, and the positioner is fixed to the image sensor board.

27. The method of manufacturing a vehicle-mounted camera according to claim 3, wherein the camera main structure assembly further includes an image sensor board on which the image sensor is mounted, and the positioner is fixed to the image sensor board.

28. The method of manufacturing a vehicle-mounted camera according to claim 4, wherein the camera main structure assembly further includes an image sensor board on which the image sensor is mounted, and the positioner is fixed to the image sensor board.

29. The method of manufacturing a vehicle-mounted camera according to claim 24, wherein the camera main structure assembly further includes an image sensor board on which the image sensor is mounted, and the positioner is fixed to the image sensor board.

30. The method of manufacturing a vehicle-mounted camera according to claim 25, wherein the positioner is fixed on the image sensor board by soldering.

31. The method of manufacturing a vehicle-mounted camera according to claim 26, wherein the positioner is fixed on the image sensor board by soldering.

32. The method of manufacturing a vehicle-mounted camera according to claim 27, wherein the positioner is fixed on the image sensor board by soldering.

33. The method of manufacturing a vehicle-mounted camera according to claim 28, wherein the positioner is fixed on the image sensor board by soldering.

34. The method of manufacturing a vehicle-mounted camera according to claim 29, wherein the positioner is fixed on the image sensor board by soldering.

35. A method of manufacturing a vehicle body, comprising:
preparing a vehicle-mounted camera by a method of manufacturing a vehicle-mounted camera according to claim 1;
preparing the vehicle body on which the vehicle-mounted camera is to be mounted;
mounting the vehicle-mounted camera on the vehicle body; and
performing directional adjustment of the vehicle-mounted camera; wherein
the vehicle-mounted camera includes a processor board connected to the camera main structure assembly and housed in the cover enclosure, and a processor circuit mounted on the processor board and that electronically processes images captured by the camera main structure assembly;
the processor circuit includes an image processing program that uses a direction error when the images captured by the camera main structure assembly are processed; and
in the directional adjustment:
an image of a target object positioned in a known direction with respect to the vehicle body is captured by the camera main structure assembly of the vehicle-mounted camera after the camera is attached to the glass surface of the vehicle body,
the image of the target object is acquired by the processor circuit,
an on-image position which is a position of the target object on the image is recognized in the processor circuit,
an original position which is a position where the target object should originally be located on the image is recognized in the processor circuit on the basis of the known direction,
the direction error is calculated in the processor circuit using the original position and the on-image position, and the calculated direction error is recorded in a form usable by the image processing program.

36. A method of manufacturing a vehicle body, comprising:
preparing a vehicle-mounted camera by a method of manufacturing a vehicle-mounted camera according to claim 2;
preparing the vehicle body on which the vehicle-mounted camera is to be mounted;
mounting the vehicle-mounted camera on the vehicle body; and
performing directional adjustment of the vehicle-mounted camera; wherein
the vehicle-mounted camera includes a processor board connected to the camera main structure assembly and housed in the cover enclosure, and a processor circuit mounted on the processor board and that electronically processes images captured by the camera main structure assembly;
the processor circuit includes an image processing program that uses a direction error when the images captured by the camera main structure assembly are processed; and
in the directional adjustment:
an image of a target object positioned in a known direction with respect to the vehicle body is captured by the camera main structure assembly of the vehicle-mounted camera after the camera is attached to the glass surface of the vehicle body,
the image of the target object is acquired by the processor circuit,
an on-image position which is a position of the target object on the image is recognized in the processor circuit,
an original position which is a position where the target object should originally be located on the image is recognized in the processor circuit on the basis of the known direction,
the direction error is calculated in the processor circuit using the original position and the on-image position, and the calculated direction error is recorded in a form usable by the image processing program.

37. A method of manufacturing a vehicle body, comprising:
preparing a vehicle-mounted camera by a method of manufacturing a vehicle-mounted camera according to claim 8;
preparing the vehicle body on which the vehicle-mounted camera is to be mounted;
mounting the vehicle-mounted camera on the vehicle body; and
performing directional adjustment of the vehicle-mounted camera; wherein
the vehicle-mounted camera includes a processor board connected to the camera main structure assembly and housed in the cover enclosure, and a processor circuit mounted on the processor board and that electronically processes images captured by the camera main structure assembly;
the processor circuit includes an image processing program that uses a direction error when the images captured by the camera main structure assembly are processed; and
in the directional adjustment:
an image of a target object positioned in a known direction with respect to the vehicle body is captured by the camera main structure assembly of the vehicle-mounted camera after the camera is attached to the glass surface of the vehicle body,
the image of the target object is acquired by the processor circuit,
an on-image position which is a position of the target object on the image is recognized in the processor circuit,
an original position which is a position where the target object should originally be located on the image is recognized in the processor circuit on the basis of the known direction,
the direction error is calculated in the processor circuit using the original position and the on-image position, and the calculated direction error is recorded in a form usable by the image processing program.

38. A method of manufacturing a vehicle body, comprising:
preparing a vehicle-mounted camera by a method of manufacturing a vehicle-mounted camera according to claim 29;
preparing the vehicle body on which the vehicle-mounted camera is to be mounted;
mounting the vehicle-mounted camera on the vehicle body; and
performing directional adjustment of the vehicle-mounted camera; wherein
the vehicle-mounted camera includes a processor board connected to the camera main structure assembly and housed in the cover enclosure, and a processor circuit mounted on the processor board and that electronically processes images captured by the camera main structure assembly;
the processor circuit includes an image processing program that uses a direction error when the images captured by the camera main structure assembly are processed; and
in the directional adjustment:
an image of a target object positioned in a known direction with respect to the vehicle body is captured by the camera main structure assembly of the vehicle-mounted camera after the camera is attached to the glass surface of the vehicle body,
the image of the target object is acquired by the processor circuit,
an on-image position which is a position of the target object on the image is recognized in the processor circuit,
an original position which is a position where the target object should originally be located on the image is recognized in the processor circuit on the basis of the known direction,
the direction error is calculated in the processor circuit using the original position and the on-image position, and the calculated direction error is recorded in a form usable by the image processing program.

39. A method of manufacturing a vehicle body, comprising:
preparing a vehicle-mounted camera by a method of manufacturing a vehicle-mounted camera according to claim 34;
preparing the vehicle body on which the vehicle-mounted camera is to be mounted;
mounting the vehicle-mounted camera on the vehicle body; and
performing directional adjustment of the vehicle-mounted camera; wherein
the vehicle-mounted camera includes a processor board connected to the camera main structure assembly and housed in the cover enclosure, and a processor circuit mounted on the processor board and that electronically processes images captured by the camera main structure assembly;
the processor circuit includes an image processing program that uses a direction error when the images captured by the camera main structure assembly are processed; and
in the directional adjustment:
an image of a target object positioned in a known direction with respect to the vehicle body is captured by the camera main structure assembly of the vehicle-mounted camera after the camera is attached to the glass surface of the vehicle body,
the image of the target object is acquired by the processor circuit,
an on-image position which is a position of the target object on the image is recognized in the processor circuit,
an original position which is a position where the target object should originally be located on the image is recognized in the processor circuit on the basis of the known direction,
the direction error is calculated in the processor circuit using the original position and the on-image position, and the calculated direction error is recorded in a form usable by the image processing program.

40. The method of manufacturing a vehicle body according to claim 35, further comprising at the time of preparing the vehicle-mounted camera:
previously preparing the plurality of types of vehicle-mounted cameras respectively having one of a plurality of positioning angles; and
selecting a vehicle-mounted camera having the one of the plurality of positioning angles selected by the predetermined method from the plurality of types of vehicle-mounted cameras.

41. A vehicle-mounted camera attached to a glass surface of a windshield inside a vehicle and facing forward or rearward of a vehicle body in a position in which the vehicle-mounted camera extends along the windshield and the vehicle-mounted camera being positioned to capture an image of a scene on a front or back side of the vehicle body, the camera comprising:
a cover enclosure including a top plate;
a camera main structure assembly fixed to the cover enclosure via a positioner;
a processor board connected to the camera main structure assembly and housed in the cover enclosure; and
a processor circuit which is mounted on the processor board and includes an image processing program that electronically processes the image captured by the camera main structure assembly, and in which a direction error in the mounting of the vehicle-mounted camera on the windshield is recorded in a form usable for the image processing; wherein
a positioner having a positioning angle selected by referring to inclination angles of the camera main structure assembly and the glass surface is fixed to the cover enclosure;
the camera main structure assembly includes a lens and an image sensor;
the top plate of the cover enclosure includes an enclosure-side seat;
the camera main structure assembly includes a camera-side seat on a surface of the camera main structure assembly;
a surface of the positioner includes an enclosure-side positioner that contacts with the enclosure-side seat at at least three enclosure-side contact points, and a camera-side positioner that contacts with the camera-side seat at at least three camera-side contact points;
at least one of the at least three enclosure-side contact points is located in a position deviated from a straight line passing through the other two points;
at least one of the at least three camera-side contact points is located in a position deviated from a straight line passing through the other two points; and
the positioning angle is a difference between a direction determined by the at least three enclosure-side contact points and a direction determined by the at least three camera-side contact points.
